(19) United States
(12) Patent Application Publication
(10) Pub. No.: US 2011/0006018 A1
(43) Pub. Date: Jan. 13, 2011

(54) HIGH VISCOSITY FLUID FILTERING SYSTEM

(75) Inventors: Raanan Ben-Horin, Kibbutz Bet Zera (IL); Itai Pomerantz, Kibbutz Ein Carmel (IL)

Correspondence Address: THE NATH LAW GROUP, 112 South West Street, Alexandria, VA, 22314, US

(73) Assignee: AMIAD FILTRATION SYSTEMS LTD., D.N. Upper Galil 1 (IL)

(21) Appl. No.: 12/920,936

(22) PCT Filed: Mar. 6, 2008
(86) PCT No.: PCT/IL08/00306

§ 371 Date: Sep. 3, 2010

(51) Int. Cl. B01D 36/02; B01D 37/00

(52) U.S. Cl. 210/806; 210/416.5; 210/323.1; 210/257.1; 210/335; 210/340; 210/295; 210/143; 210/333.01; 210/411; 210/767

(57) ABSTRACT

There is provided herein a system for filtering oils and/or emulsions including one or more filtering devices comprising stacked filtering elements configured to filter oils and/or emulsions, one or more tanks configured to hold oils and/or emulsions, and one or more pumps configured to pump oils and/or emulsions.

### FIELD

The invention relates to filtration systems for removing particulate material from fluids, such as oils and emulsions.

### BACKGROUND

Different types of filtering systems are known in the art, and are used with varying degrees of efficacy, to separate particle contaminants from liquids, which exhibit different properties than those of water. Some of these properties may include viscosity, surface tension, density, electrical characteristics, optical characteristics (such as transparency, refractivity, reflectivity, or the like), polarity, and/or capillary action, stability of changing in changing temperatures, biological activity and others. For convenience hereinafter, liquids exhibiting different properties than those of water may be referred to as “fluids”, and liquids comprising particulate contaminants may be referred to as “contaminated fluids”.

Filtering systems for fluids have relatively wide applications in food production, cosmetics manufacturing, hygienic products manufacturing (soaps, shampoos and the like), pharmaceutical products manufacturing, petroleum refining, and machining operations, among others. An example of the use of fluid filtering systems in food production is in the production of nectars and thick fruit juices, where the filtering system may be required to remove particulate contamination originating from pulps and seeds. Another example may be in the production of consumable oils, such as olive oil, corn oil, and the like, where the filtering system may be required to remove particulate contamination originating from raw products from which the oils are extracted.

In machining operations, fluid filtering systems are commonly used to filter oils and emulsions which are frequently used for lubricating and cooling machining equipment, for example, lathing machines, grinding machines, drilling machines, cutting machines, and the like, and also more advanced machining equipment such as CNC (computer numerical control) systems, and the like. An important function of the oils and/or emulsions used in machining processes is to collect and remove particulate (particles) that are formed during the processing. The removal of the particulates from the contact point(s) between a cutting tool and the work piece prevents the particulates from interrupting (for example by blocking passes between the tools and the work piece) during the cutting process. Optionally, the fluids are used for cleaning work areas, including a tool and/or work piece. The fluids are generally used to lubricate and cool components in the machining equipment, in order to protect them from mechanical and/or thermal stresses possibly resulting from friction, wear, corrosion, and/or high operating temperatures. The fluids are usually collected in collection tanks, which may be placed at one or more locations throughout the filtering system, and/or at the end of the system. The collected fluids are generally recycled back into the equipment, which usually results in substantial cost savings in the machining operations. Prior to recycling, the fluid is typically filtered to remove contaminating particles, which may have accumulated in the fluid during the machining operation and may have collected in the tanks. Examples of these contaminating particles may be relatively large chips, micro chips, and/or granules which may separate from cutting tools, grinding tools and/or the work pieces.

Recycling contaminated fluid into the machining equipment may cause equipment components to be damaged, and may subsequently lead to equipment breakdown. The rate at which damage may occur in equipment components is generally dependent on the quantity and the size of the particles, on the pressure at which contaminated fluid flows through the equipment components, and on the internal clearances of parts comprised in the components. Particles of approximately the same size as a clearance may cause damage to the part through friction. Particles of a smaller size than the clearance may cause damage to the part through abrasion at relatively high pressure flow rates. Friction and abrasion generally contribute to accelerated wear in the parts and to eventual component breakdown. Equipment components, which may require relatively frequent replacement due to wear, may include, for example, pumps, spindles, and axes. Particles of a larger size than the clearance may create blockages, wholly or partially, in the path of flow of the contaminated fluid through a component. Interrupting the flow of the fluid through the component may result in damage to the component, and may affect other components following the blocked components. Equipment components, which require relatively frequent replacement due to blockage, may include, for examples, pipes, pumps, valves, tools, and nozzles.

Furthermore, recycling contaminated fluid may affect the quality of a work piece. For example, surfaces on the work piece may be damaged by the impact of the contaminating particles, especially if the fluid is sprayed at a high pressure. Optionally, the tool may be damaged by a contaminating particle during the machining process, the damage in the tool reflected in a poor surface finish in the work piece. In some cases, depending on the size and/or quantity of contaminating particles, control of surface finishing on the work pieces may not be possible, occasionally resulting in a relatively large number of defective work pieces.

The use of contaminated fluids and/or inadequate filtering may result in work stoppage on a production floor, sometimes for hours and/or even days. In some cases, work may be stopped in order to clean sludge tanks in which particles have accumulated. In other cases, blockages in equipment components require stopping production in order to locate and repair the blockage. In some other cases, component failure requires stopping production to replace or repair the failed component. In even some other cases, flooding may occur on the production floor requiring work to be stopped.

Fluid filtering systems generally used in machining operations may include the use of a hydrocyclone (cyclone) filter, paper gravity filter, centrifuge filter, drum filter, candle filter and precoated filter, and/or paper and/or polymeric cartridge filtering. Following are brief descriptions of each type of filtering.

a. Hydrocyclone filter uses centrifugal force to separate particles from the contaminated fluid. The separated particles drop into a reservoir where they accumulate and are later removed. Some advantages of the hydrocyclone include high removal rates for relatively heavy weight particles. Additionally, the hydrocyclone is generally of a relatively simple construction and compactly sized. A major disadvantage in the use of the hydrocyclone is a relatively large volume of fluid flow into filter drain components, possibly comprising up to 15% of the volume of the contaminated fluid. Recycling this relatively large volume of fluid in the drain components may result in a costly operation. Additionally, there is a risk in emulsions breaking down into oil and water due to their different densities.
b. Paper gravity filters generally comprise a paper band adapted to retain particles in contaminated fluids as the contaminated fluid flows through the paper band. For convenience hereinafter, a filtered fluid may be referred to as “clean fluid”. Advantages in using the paper gravity filter include a relatively simple and inexpensive construction; relatively low costs involved in replacing the paper band; and disposing of the paper band generally has little, if any, impact on the environment (environmentally friendly material). A disadvantage in using the paper gravity filter is its relatively low reliability.
c. Centrifuge filter generally comprises a cylinder which substantially rapidly rotates the particulates through towards the cylinder walls, such that clean fluid is driven out of the cylinder through the periphery by a centrifugal action. Contaminating particles in the fluid remain trapped inside the cylinder and may be automatically, or optionally, manually, discharged. Some advantages of the centrifuge include a relatively compact size, an ability to separate heavy particles from the contaminated fluid, internal storing of sludge (the contaminating particles removed from the contaminated fluid). Some disadvantages include a relatively high purchase cost, noisy operation, the general need to have frequent manual removal of sludge, and a relatively large volume of fluid flow into filter drain components, possibly comprising up to 15% of the volume of the contaminated fluid, which may result is costly recycling operations. Additionally, there is a risk in emulsions breaking down into oil and water due to their different densities.
d. Drum filter is generally adapted to remove relatively large particles in contaminated fluid, usually in operations involving rough machining. Some advantages of the drum filter include automatic backwash, generally integrated in conveyor belts used in machining operations, saving production floor space. Backwash is a process generally used in some filtering methods typically comprising flushing a fluid in the opposite direction to that of the flow of a fluid being filtered, in order to remove accumulated particles in the filtering elements. Some disadvantages include production shutdowns due to filter failure, high wear in sealing device, and unsuitability for relative small particle filtering, and backwash nozzle blockage which may cause production floor flooding. Additionally, tears in the drum filter screen are generally difficult to spot, allowing the contaminated fluid to flow through the tear into clean tanks contaminating the clean fluid inside the tanks. The contaminated fluid may cause blockages in pipes and other system components, interfering with the production process.
e. Candle filter and the precoated filter, are generally used as a fine filter for finishing operations. Relative advantages include fine filtration capabilities, relatively low purchase cost, and disposal of the filter generally has little, if any, impact on the environment (environmentally friendly material). Some disadvantages include variations in stability while filtering.
f. Paper and/or polymeric cartridge filter is generally adapted to filter contaminated fluids in applications as a polisher filter, and as a safety filter to protect a component. Relative advantages include a relatively low purchase cost, and disposing of the filter generally has little, if any, impact on the environment (environmentally friendly material). A disadvantage in using the paper and/or polymeric cartridge filter is its relatively low reliability.

The terms “contamination”, “contaminated” or “contaminating” as referred to herein may include any element present in a fluid, which is not dissolved in the fluid. Such elements may include, for example but are not limited to, solid elements, residues, liquid containing elements, suspended solids and the like.

### SUMMARY

An aspect of some embodiments of the invention relates to providing a filtering system adapted to remove particulate contamination (particles) from contaminated fluids, such as, for example, particulate contaminated oils and/or emulsions, for use in machining operations as lubricants and/or coolants.

An aspect of some embodiments of the invention relates to providing a filter system adapted to remove particulate contamination from contaminated fluids, wherein the particles have essentially a needle shape or essentially a cork-screw shape, for example, metal particles (such as, stainless steel, iron, copper, aluminum, tempered steel, alloys, glass, diamond, polycarbonate, and the like).

An aspect of some embodiments of the invention relates to providing a filter system adapted to remove particulate contamination from contaminated fluids, wherein the particles are produced in machining operations comprising, for example, lathing, grinding, drilling, cutting, or CNC (computer numerical control) processes among others, for example, of metals (such as, stainless steel, cast iron, copper, aluminum, tempered steel, and the like), polymers (such as PP—polypropylene, PA—polyacetylene, PE—polyethylene, PTFE—polytetrafluoroethylene, PA66—polyamide, POM—polyoxymethylene, polycarbonate, and the like), ceramics, carbon, glass, diamonds, sapphire, and the like, extra-soft materials (such as, Styrofoam, soft plastic, sponges, and the like).

According to an aspect of some embodiments of the invention, the filtering system comprises a filtering device including a filter and a plurality of relatively tightly stacked, relatively flat filtering elements, the filtering device adapted to trap the particles in the contaminated fluid. Optionally, the filtering system may comprise a plurality of filtering devices, for example, 2, 3, 4, 5, 6, 7, 8, 9, 10, or more. The plurality of filtering devices may be serially and/or parallelly connected, or any combination thereof. The filter device, or optionally the plurality of filtering devices, may be adapted to filter particles of one size range, or may optionally be adapted to filter particles of different size ranges. Optionally, the filtering device may be connected, using proper connection means, to other types of filters known in the art, for example, hydrocyclone (cyclone) filter, paper gravity filter, centrifuge filter, drum filter, candle filter and precoated filter, and/or paper and/or polymeric cartridge filtering, among others.

The filtering elements may comprise a circular shape, or optionally, an elliptical shape, a rectangular shape, or any regular polygonal shape, or irregular shape including irregular polygonal shape. The filtering elements comprise channels on both sides, substantially flat surfaces separating between the channels. Optionally, the filtering elements may comprise channels only on one side. The channels slantedly extend from an outer perimeter towards an inner perimeter, generally conforming to a direction of flow of the fluid. The inner perimeter forms a border of an opening located inside the filter element. Optionally, the channels may slantedly extend a portion of a distance to the inner perimeter. Optionally, the filtering elements may comprise a plurality of support points. Additionally, the channels on one side of a filtering element are slanted in a same direction as on a second side of the filtering element.

The filtering elements are further adapted to stack such that the channels on one side of a first filtering element may partially, or fully, align with the channels or flat surfaces on an adjoining side of a second filtering element. Partial or full alignment of a channel on one side of the first filtering element with a channel on the adjoining side of the second filtering element forms a conduit through which the contaminated fluid may flow from the outer perimeter of the filtering elements into the opening in the filtering elements. A conduit may also be formed by the alignment of a channel on one side of the first filtering element with a flat surface on the adjoining side of the second filtering element. Optionally, the contaminated fluid may flow from the opening in the filtering elements in a direction from the inner perimeter to the outer perimeter. For convenience hereinafter, contaminated fluid flowing through a conduit may be referred to as “filter fluid”, and that which has flowed through a conduit may be referred to as “clean fluid”. The cross-sectional characteristics, such as size and shape, of the conduits may vary from conduit to conduit according to how the channels and/or flat surfaces align. Additionally, the cross-sectional characteristics of the conduit may vary along the length of the conduit, generally as the conduit nears the opening. The conduits are adapted to trap particles of different sizes in the filter fluid as the fluid flows through the conduit, the size and shape of the trapped particles generally determined, among others, by the channel dimensions (width and depth of the channel) and the cross-sectional characteristics of the conduit. A single conduit may trap one or more particles of different sizes, the size of the particles may decrease as the conduit nears the opening. Optionally, the size of the particles may increase as the conduit nears the opening. The conduit may further be adapted to substantially prevent particles larger than a conduit aperture from entering into the conduit.

The filtering elements may be formed from a polymeric material, such as PP, PA, PTFE, rubber, silicon and the like. Optionally, the filtering elements may include an antibacterial material, such as but not limited to, antibiotics, in order to prevent or reduce bacterial growth on the filtering elements, in the fluid and/or in any component of the filtering system. Optionally, the filtering elements may be coated with an antibacterial material. Additionally or alternatively, the filtering elements may also include an antibacterial material incorporated in the filter material itself. The antibacterial material may include, quarternary ammonium compounds, triclosan, tolyl diiodomethyl sulfone, zinc pyrithione, sodium pyrithione, ortho phenylphenol, sodium ortho phenylphenol, iodo-2-propynyl butylcarbamate, poly[oxyethylene(dimethyliminio) ethylene(dimethyliminio)ethylene chloride], propiconazole, tebuconazole, bethoxazin, thiabendazole, polyhexamethylene biguanide, and 1,3,5-triazine-1,3,5-(2H,4H,6H)-triethanol, isothiazalinones, or any combination thereof. Optionally, the antibacterial material may include, metal salts, such as, salts of silver, copper, zinc, mercury, tin, lead, bismuth, barium, cadmium, chromium, or any combination thereof. The silver salts may include silver acetate, silver benzoate, silver carbonate, silver iodate, silver iodide, silver lactate, silver laurate, silver nitrate, silver oxide, silver palmitate, silver sulfadiazine, ceramics containing silver, zeolites containing silver, or any combination of any of the materials disclosed herein or any other appropriate antibacterial material. Similarly, other materials, such as antifungal materials, may also be utilized.

The filtering device is further adapted to automatically switch to backwash operation, responsive to detection of a predefined pressure difference in the flow of clean fluid. Optionally, the filtering device may be manually switched to a backwash operation. A pressure difference equal to or above a predefined level, for example in a range of 0.5-1.0 bar, in the clean fluid is indicative of a blockage in the filter. Responsive to the blockage, the tightly stacked elements are automatically released so that they may be free to rotate. A flushing fluid, which may be, for example, a relatively small amount of the clean fluid, may then be flushed into the filtering device in order to remove particles stuck between the elements. Optionally, a gas, for example nitrogen, and/or a gaseous mixture such as air, may be flushed into the filtering device. Optionally, the gas may be adapted to disinfect the filtering device, for example, chlorine gas. Additionally or alternatively, the gas or gaseous mixture may be combined with the fluid and then flushed into the filtering device. Optionally, the gas may be an inert gas at a high temperature. Optionally, upon termination of backwash, the tightening of the stacked elements may be performed automatically. Optionally, the tightening of the stacked elements may be performed manually.

In an embodiment of the invention, the filtering system is adapted to perform full-stream filtration of contaminated fluids for machining equipment. The contaminated fluid is collected in one or more collection tanks, and is then pumped into the filtering device, which may be a plurality of filtering devices, for filtering. The filtering device may be adapted to filter the contaminated fluid, at least, at a predetermined flow rate capacity required by the machining equipment. Following filtering, the clean fluid is collected into one or more clean tanks, from where the clean fluid is pumped to the machining equipment for use as a lubricant and/or coolant for equipment components (tools) and/or a work piece. Optionally, the clean fluid may flow from the clean tank into the machining equipment by gravitation. Optionally, the clean tank is comprised in the machining equipment. During backwash operations, the flushing fluid flows out of the filtering device into a drain adapted to collect the flushing fluid. In some embodiments of the invention, the drain may be connected to the contaminated fluid collection tank for recycling of the flushing fluid. The drain may include a tank and/or any system adapted to clean fluids, for example, a system having a filter, a cyclone, a centrifuge, a precipitation capability or the like.

In another embodiment of the invention, the filtering system is adapted to perform side-stream filtration of contaminated fluids for machining equipment. The contaminated fluid is collected in one or more collection tanks, and a portion of the contaminated fluid, in a range from 5%-20% of a predetermined flow rate capacity of the machining equipment, for example, 10% of the volume, is pumped into the filtering device for filtering. Optionally, the filtering device may comprise a plurality of filtering devices. Following filtering, the clean fluid is returned to the contaminated fluid collection tank for mixing with the contaminated fluid. Mixed fluid is then pumped into one or more clean tanks, at least, at a predetermined flow rate capacity required by the machining equipment, and from where the mixed fluid is pumped to the machining equipment. Optionally, the clean fluid may flow from the clean tank into the machining equipment by gravitation. Optionally, the clean tank is comprised in the machining equipment. During backwash operations, the flushing fluid flows out of the filtering device into a drain, for example a drain system adapted to collect the flushing fluid. In some embodiments of the invention, the drain may be directly, or indirectly, connected to the contaminated fluid collection tank.

In another embodiment of the invention, the filtering system is adapted to perform pre-filtered, full-stream filtration of contaminated fluids for machining equipment. The contaminated fluid is collected in one or more collection tanks, and is then pumped through a pre-filter device into one or more collection tanks adapted to collect a semi-clean fluid. The pre-filter device, adapted to partially filter the contaminated fluid, may comprise other types of filters known in the art, for example, hydrocyclone (cyclone) filter, paper gravity filter, centrifuge filter, drum filter, candle filter and precoated filter, and/or paper and/or polymeric cartridge filtering, among others. Optionally, the pre-filter device may comprise a plurality of pre-filter devices. The semi-clean fluid is then pumped into the filtering device, which may be a plurality of filtering devices, for filtering. The filtering device may be adapted to filter the semi-clean fluid, at least, at a predetermined flow rate capacity required by the machining equipment. Following filtering, the clean fluid is collected into one or more clean tanks, from where the clean fluid is pumped to the machining equipment for use as a lubricant and/or coolant for the equipment components (tools) and/or a work piece. Optionally, the clean fluid may flow from the clean tank into the machining equipment by gravitation. Optionally, the clean tank is comprised in the machining equipment. During backwash operations, the flushing fluid flows out of the filtering device into a drain, for example a drain system adapted to collect the flushing fluid. In some embodiments of the invention, the drain may be connected to the contaminated fluid collection tank for recycling of the flushing fluid. Additionally, a flushing fluid comprising semi-clean fluid is pumped through the pre-filter device during pre-filter device backwash, the flushing fluid collected in a pre-filter drain. In some embodiments of the invention, the pre-filter drain may be connected to the contaminated fluid collection tank for recycling of the flushing fluid.

In another embodiment of the invention, the filtering system is adapted to perform pre-filtered, side-stream filtration of contaminated fluids for machining equipment. The filtering system additionally comprises a polisher filter, although in some embodiments of the invention the filtering system does not comprise a polisher filter. The contaminated fluid is collected in one or more collection tanks, and is then pumped through a pre-filter device into one or more collection tanks adapted to collect a semi-clean fluid. The pre-filter device, adapted to partially filter the contaminated fluid, may comprise other types of filters known in the art, for example, hydrocyclone (cyclone) filter, paper gravity filter, centrifuge filter, drum filter, candle filter and precoated filter, and/or paper and/or polymeric cartridge filtering, among others. Optionally, the pre-filter device may comprise a plurality of pre-filter devices. The semi-clean fluid is collected in one or more semi-clean collection tanks, and a portion of the semi-clean fluid, in a range from 5%-20% of a predetermined flow rate capacity of the machining equipment, for example, 10% of the volume, is pumped into the filtering device for filtering. Optionally, the filtering device may comprise a plurality of filtering devices. Following filtering, the clean fluid is returned to the semi-clean fluid collection tank for mixing with the semi-clean fluid. Mixed semi-clean fluid is then pumped through a polisher filter, which may be, for example, a cartridge filter, into one or more clean tanks, the polisher filter adapted to filter substantially small particles contaminating the mixed semi-clean fluid. The polisher filter is further adapted to filter the mixed semi-clean fluid, at least, at a predetermined flow rate capacity required by the machining equipment. The polisher fluid is then pumped to the machining equipment for use as a lubricant and/or coolant for the equipment components (tools) and/or a work piece. Optionally, the polisher fluid may flow from the clean tank into the machining equipment by gravitation. Optionally, the clean tank is comprised in the machining equipment. During backwash operations, the flushing fluid flows out of the filtering device into a drain for example a drain system adapted to collect the flushing fluid. In some embodiments of the invention, the drain may be connected to the contaminated fluid collection tank for recycling of the flushing fluid. Additionally, a flushing fluid comprising semi-clean fluid is pumped through the pre-filter device during pre-filter device backwash, the flushing fluid collected in a pre-filter drain. In some embodiments of the invention, the pre-filter drain may be connected to the contaminated fluid collection tank for recycling of the flushing fluid.

In another embodiment of the invention, the filtering system is adapted to perform pre-filtered, full-stream filtration of contaminated fluids for a grinding machine. The contaminated fluid is collected in one or more collection tanks, and is then pumped through a pre-filter device into one or more collection tanks adapted to collect a semi-clean fluid. The pre-filter device, adapted to partially filter the contaminated fluid, may comprise other types of filters known in the art, for example, hydrocyclone (cyclone) filter, paper gravity filter, centrifuge filter, drum filter, candle filter and precoated filter, and/or paper and/or polymeric cartridge filtering, among others. Optionally, the pre-filter device may comprise a plurality of pre-filter devices. The semi-clean fluid is then pumped into the filtering device, which may be a plurality of filtering devices, for filtering. The filtering device may be adapted to filter the semi-clean fluid, at least, at a predetermined flow rate capacity required by the grinding machine. Following filtering, the clean fluid is collected into one or more clean tanks, from where the clean fluid is pumped to the grinding machine for use as a coolant and to clean the grinding area, including the tool and the work piece. Optionally, the clean fluid may flow from the clean tank into the grinding machine by gravitation. Optionally, the clean tank is comprised in the grinding machine. During backwash operations, the flushing fluid flows out of the filtering device into a drain, for example a drain adapted to collect the flushing fluid. In some embodiments of the invention, the drain may be connected to the contaminated fluid collection tank for recycling of the flushing fluid. Additionally, a flushing fluid comprising semi-clean fluid is pumped through the pre-filter device during pre-filter device backwash, the flushing fluid collected in a pre-filter drain. In some embodiments of the invention, the pre-filter drain may be connected to the contaminated fluid collection tank for recycling of the flushing fluid.

In another embodiment of the invention, the filtering system is adapted to directly perform filtration of contaminated fluids for machining equipment. The contaminated fluid is pumped directly into the filtering device, which may be a plurality of filtering devices, for filtering. The filtering device may be adapted to filter the contaminated fluid, at least, at a predetermined flow rate capacity required by the machining equipment. Following filtering, the clean fluid is collected into one or more clean tanks, from where the clean fluid is pumped to the machining equipment for use as a lubricant and/or coolant for equipment components (tools) and/or a work piece. Optionally, the clean fluid may flow from the clean tank into the machining equipment by gravitation. Optionally, the clean tank is comprised in the machining equipment. Optionally, the clean tank is connected to a chiller adapted to cool the clean fluid. During backwash operations, the flushing fluid flows out of the filtering device into a drain system adapted to collect the flushing fluid. The drain may optionally be connected to a briquette machine adapted to briquette the contaminating particles filtered out of the fluid.

The embodiments described are for exemplary purposes only and are not intended to be limiting in any form or manner. A person skilled in the art may appreciate that the filtering device may be connected in the filtering system in numerous ways and combinations. Furthermore, the filtering system may comprise numerous types of components and/or equipment additionally or alternatively to those described, for example, agglomeration equipment, magnets, such as electro-magnets, chemical treatment, ultrasound treatment and other components, equipment like fluid make-up system (water treatment, concentrate dosing station, level switch), and tramp oil separator.

There is provided, in accordance with an embodiment of the invention, a system for filtering oils and/or emulsions comprising one or more filtering devices comprising stacked filtering elements adapted to filter oils and/or emulsions, one or more tanks adapted to hold oils and/or emulsions, and one or more pumps adapted to pump oils and/or emulsions. Optionally, the system is adapted to filter oils and/or emulsions used in machining operations

In some embodiments of the invention, the tank is a contaminated fluid tank adapted to hold non-filtered oils and/or emulsions. Optionally, the tank is further adapted to hold mixed non-filtered and filtered oils and/or emulsions. Optionally, the tank is a semi-clean fluid tank adapted to hold pre-filtered oils and/or emulsions. Optionally, the semi-clean fluid tank is further adapted to hold mixed pre-filtered and filtered oils and/or emulsion. Additionally or alternatively, the tank is a clean fluid tank adapted to hold filtered oils and/or emulsion.

In some embodiments of the invention, the system further comprises a drain. Optionally, the system further comprises a briquetting machine.

In some embodiments of the invention, the system further comprises a pre-filter. Optionally, the pre-filter is a paper and/or polymeric cartridge filter. Optionally, the pre-filter is adapted to perform automatic backwash.

In some embodiments of the invention, the system further comprises a polisher filter. Optionally, the polisher filter is a paper and/or polymeric cartridge filter.

In some embodiments of the invention, the pumps are adapted to pump non-filtered oils and/or emulsions. Optionally, the pumps are adapted to pump pre-filtered oils and/or emulsions. Additionally or alternatively, the pumps are adapted to pump mixed non-filtered and pre-filtered oils and/or emulsions. Optionally, the pumps are adapted to pump mixed filtered and pre-filtered oils and/or emulsions. Optionally, the pumps are adapted to pump filtered oils/and or emulsion.

In some embodiments of the invention, the filtering devices may be connected in series and/or in parallel. Optionally, the filtering devices are adapted to filter particulate contaminants in only one size range. Optionally, the filtering devices are adapted to filter particulate contaminants of various size ranges. Optionally, the filtering devices are adapted to perform automatic backwash.

In some embodiments of the invention, the pumps may be automatically activated. Optionally, the pumps may be automatically deactivated.

There is provided, in accordance with an embodiment of the invention, a method for filtering oils and/or emulsions used in machining operations comprising filtering oils and/or emulsions with one or more filtering devices comprising stacked filtering elements adapted to filter oils and/or emulsions; holding oils and/or emulsions in tanks; and pumping oils and/or emulsions.

### BRIEF DESCRIPTION OF FIGURES

Examples illustrative of embodiments of the invention are described below with reference to figures attached hereto. In the figures, identical structures, elements or parts that appear in more than one figure are generally labeled with a same numeral in all the figures in which they appear. Dimensions of components and features shown in the figures are generally chosen for convenience and clarity of presentation and are not necessarily shown to scale. The figures are listed below.

FIG. 1A schematically shows an exemplary filtering device for viscous fluids, in accordance with an embodiment of the invention;

FIG. 1B schematically shows an exemplary filtering device for viscous fluids, in accordance with some embodiments of the invention;

FIG. 2A schematically shows a top view of an exemplary filter disk, in accordance with an embodiment of the invention;

FIG. 2B schematically shows a cross-sectional view A-A of the exemplary disk of FIG. 2A, in accordance with an embodiment of the invention;

FIG. 2C schematically shows a top view of an exemplary filter disk, in accordance with some embodiments of the invention;

FIG. 2D schematically shows a top view of an exemplary filter disk, in accordance with some embodiments of the invention;

FIG. 2E schematically shows exemplary filtering elements comprising different cross-sections, A through E, in accordance with some embodiments of the invention;

FIG. 2F schematically shows exemplary filtering elements comprising different shapes, A through I, and further comprising different shaped openings, in accordance with some embodiments of the invention;

FIG. 2G schematically shows a face view of an exemplary filter disk comprised in a filter, in accordance with some embodiments of the invention;

FIGS. 3A, 3B, 3C, and 3D schematically show cross-sectional views of exemplary channels formed between two adjoining disk surfaces, in accordance with an embodiment of the invention;

FIG. 3E schematically shows an algorithmic flow diagram for filtering and backwash operations in a filtering device 300 adapted to filter contaminated fluid using different filter grades, in accordance with an embodiment of the invention;

FIG. 4 schematically shows a flow diagram of an exemplary filtering system adapted to perform full-stream filtration of contaminated fluids for machining equipment, in accordance with an embodiment of the invention;

FIG. 5 schematically shows a flow diagram of an exemplary filtering system adapted to perform side-stream filtration of contaminated fluids for machining equipment, in accordance with an embodiment of the invention;

FIG. 6 schematically shows a flow diagram of an exemplary filtering system adapted to perform pre-filtered, full-stream filtration of contaminated fluids for machining equipment, in accordance with an embodiment of the invention;

FIG. 7 schematically shows a flow diagram of an exemplary filtering system adapted to perform pre-filtered, side-stream filtration of contaminated fluids for machining equipment, and additionally comprising a polisher filter, in accordance with an embodiment of the invention;

FIG. 8 schematically shows a flow diagram of an exemplary filtering system adapted to perform pre-filtered, full-stream filtration of contaminated fluids for a grinding machine, in accordance with an embodiment of the invention; and

FIG. 9 schematically shows a flow diagram of an exemplary filtering system adapted to directly perform filtration of contaminated fluids for machining equipment, in accordance with an embodiment of the invention.

### DETAILED DESCRIPTION

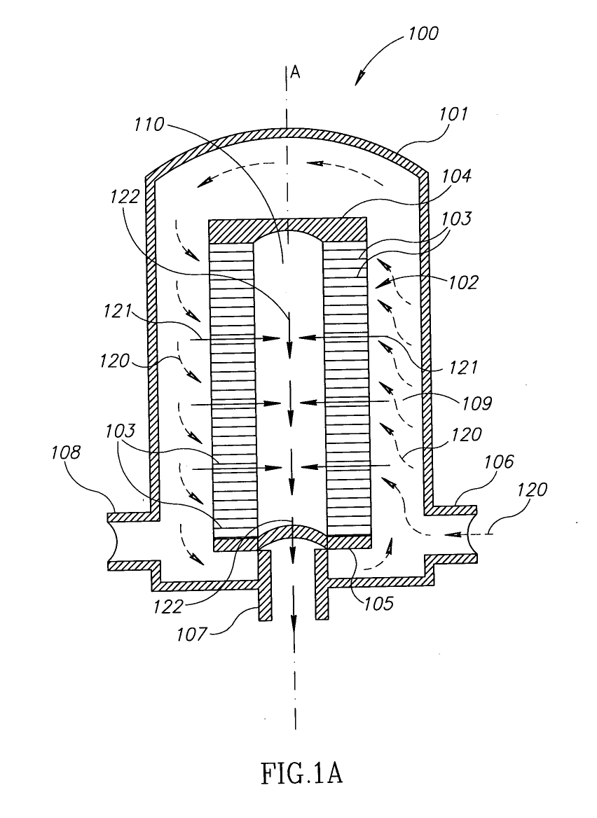

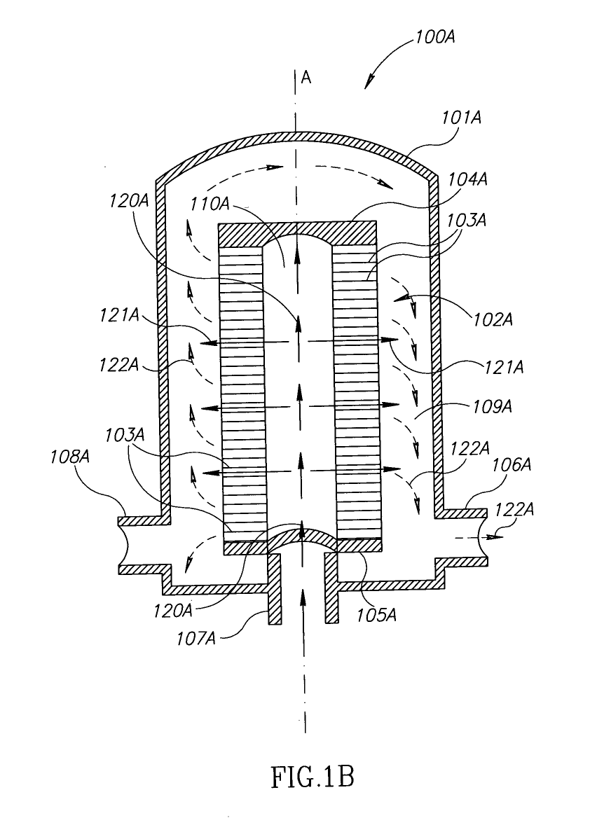

Reference is made to FIG. 1A, which schematically shows a longitudinal sectional view of an exemplary filtering device for contaminated fluids 100, in accordance with an embodiment of the invention. Filtering device 100 includes a housing 101 adapted to receive in an outer chamber 109, contaminated fluids 120, shown by hatched arrows, arriving at a relatively high pressure through an inlet 106. Inlet 106 is shown at one end of housing 101 although inlet 106 may optionally have other locations in housing 101. Housing 101 is further adapted to facilitate flow of contaminated fluid 120 as the fluid spreads throughout outer chamber 109. For example, housing 101 may comprise a cylindrical shape and a dome at one end, as shown, or optionally, housing 101 may conceivably comprise other shapes, for example, cylindrical with a dome at each end, or spherical, or ellipsoidal, or quadrilateral, or any other polyhedral shape, or any combination of polyhedral shapes.

Filtering device 100 additionally includes a filter 102, which comprises a plurality of filtering elements 103, tightly stacked together. Filtering device 100 further comprises an inner chamber 110 running longitudinally through the center of filtering elements 103. Filtering elements 103 are concentrically disposed about an axis A extending longitudinally through a center of both housing 101 and inner chamber 110. Optionally, filtering elements 103 may be eccentrically disposed about axis A. Additionally or alternatively, axis A is not centered in housing 101.

In accordance with an embodiment of the invention, filter 102 is adapted to filter particles contaminating contaminated fluid 120 as the fluid flows between filtering elements 103 in the filter into inner chamber 110. Particles which are filtered are those substantially prevented from entering between filtering elements 103, or are trapped between the filtering elements, the size of the particles determined by a predetermined filtering size range of the filtering elements. For convenience hereinafter, contaminated fluid 120 flowing through filter 102, may be referred to as filter fluid 121, shown in the figure by a thin arrow. Filter fluid 121 flowing into inner chamber 110 is relatively free of contaminating particles, and may be hereinafter referred to as clean fluid 122, shown by thick arrows. Inner chamber 110 connects at one end to an outlet 107 comprised in housing 101, outlet 107 adapted to conduct the flow of clean fluid 122, out of filtering device 100.

Stacked filtering elements 103 are held tightly in place by a first clamp 104 and a second clamp 105, one at each end of filter 102. Clamps 104 and 105 are adapted to tightly clamp stacked filtering elements 103 for filtering contaminated fluid 120, and to loosely clamp stacked filtering elements 103 for backwash operations associated with blockages in filter 102. First clamp 104 and second clamp 105 may be electrically initiated by an electrical signal received responsive to a pressure change in the flow of clean fluid 122 due to blockage, and optionally, by an electrical signal received responsive to removal of the blockage.

During backwash operations, stacked filtering elements 103 are released such that they are loosely stacked. A fluid used for backwash, which may be, for example, a relatively small quantity of clean fluid 122, or optionally a gas or a gaseous mixture, or any combination thereof, is introduced at a relatively high pressure from outside filtering device 100 through outlet 107 into inner chamber 110. Alternatively, the fluid may be introduced into inner chamber 110 through a flushing fluid inlet (not shown). The pressurized fluid then flows from inner chamber 110 between loosely stacked filtering elements 103 into outer chamber 109. This “reverse” flow of fluid, that is, from the inner chamber into the outer chamber, substantially displaces particles trapped between elements 103, which flow into outer chamber 109. The fluid in outer chamber 109, which may include both displaced trapped particles and particles which did not enter between the disks during filtering, flows out of filtering device 100 through a flushing fluid outlet 108 comprised by housing 101. In some embodiments of the invention, the fluid flows out of filtering device 100 through inlet 106.

Reference is made to FIG. 1B, which schematically shows a longitudinal sectional view of an exemplary filtering device for contaminated fluids 100A, in accordance with some embodiments of the invention. Filtering device 100A comprises a housing 101A, a filter 102A comprising filtering elements 103A, a first clamp 104A, a second clamp 105A, an outlet 106A, an inlet 107A, a flushing fluid inlet 108A, an outer chamber 109A, and an inner chamber 110A. Housing 101A, first clamp 104A, second clamp 105A, outer chamber 109A, and inner chamber 110A, are the same or substantially similar to that shown in FIG. 1 at 101, 104, 105, 109, and 110, respectively.

In filter device 100A, contaminated fluid 120A comprising contaminating particles, shown by thick solid arrows, flows through inlet 107A at a relatively high pressure into inner chamber 110A. Contaminated fluid 120A flows from inner chamber 110A through filtering elements 103A comprised in filter 102A. Filter 102A, when filtering elements 103 are tightly stacked by the clamping action of clamps 104A and 105A, is adapted to filter contaminated fluid 120A. For convenience hereinafter, contaminated fluid 120A flowing through filter 102A may be hereinafter referred to as filter fluid 121A, shown by a thin solid arrow. Filter fluid 121A flows into outer chamber 109A relatively free of contaminating particles, and may be hereinafter referred to as clean fluid 122A, shown by hatched arrows. Clean fluid 122A flows out of filter device through outlet 106A. During backwash, the flushing fluid may flow into filtering device 100A through outlet 106A, or optionally, flushing fluid inlet 108A, and flushed out through inlet 107A, or optionally, through a flushing fluid outlet (not shown).

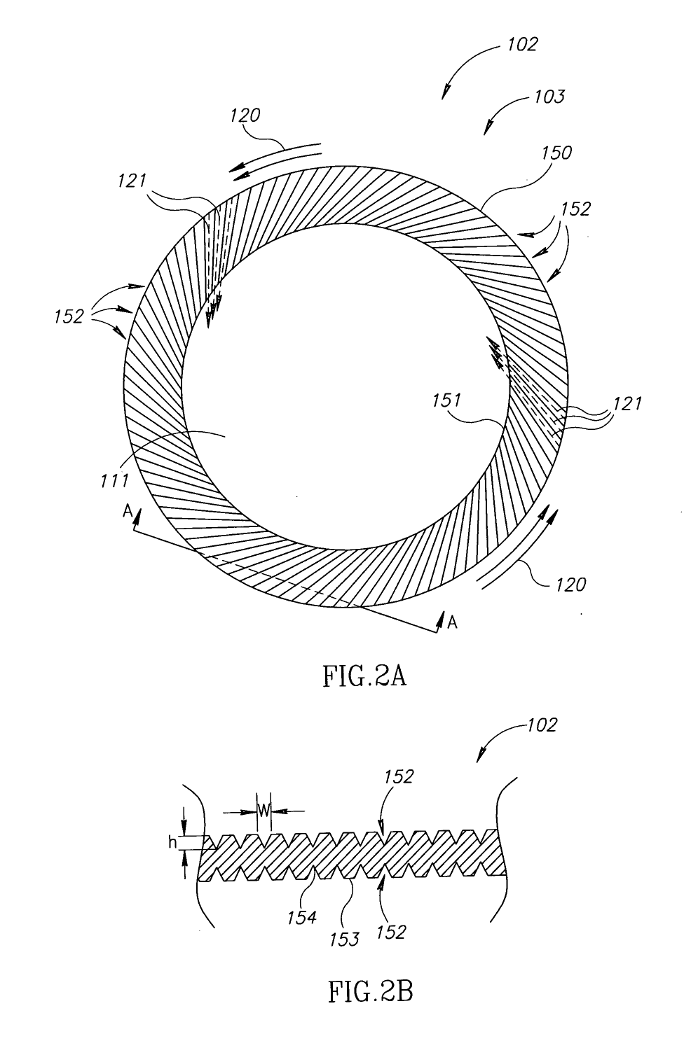

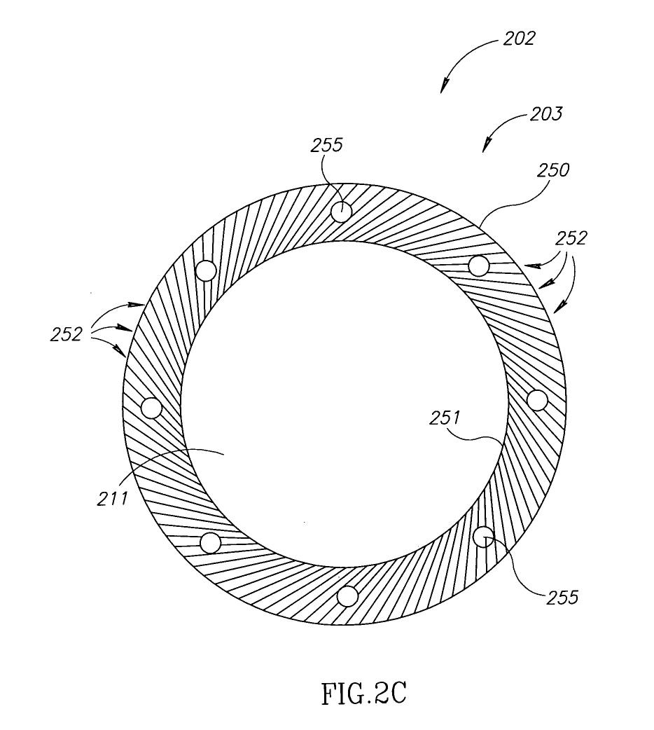

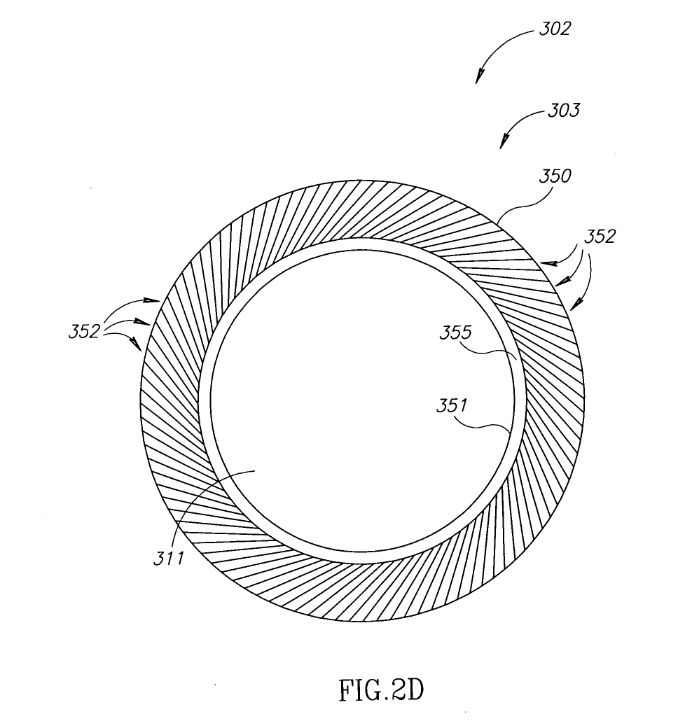

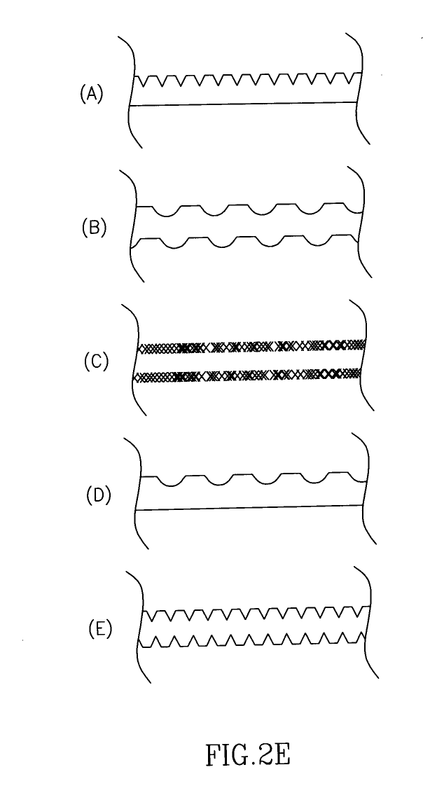

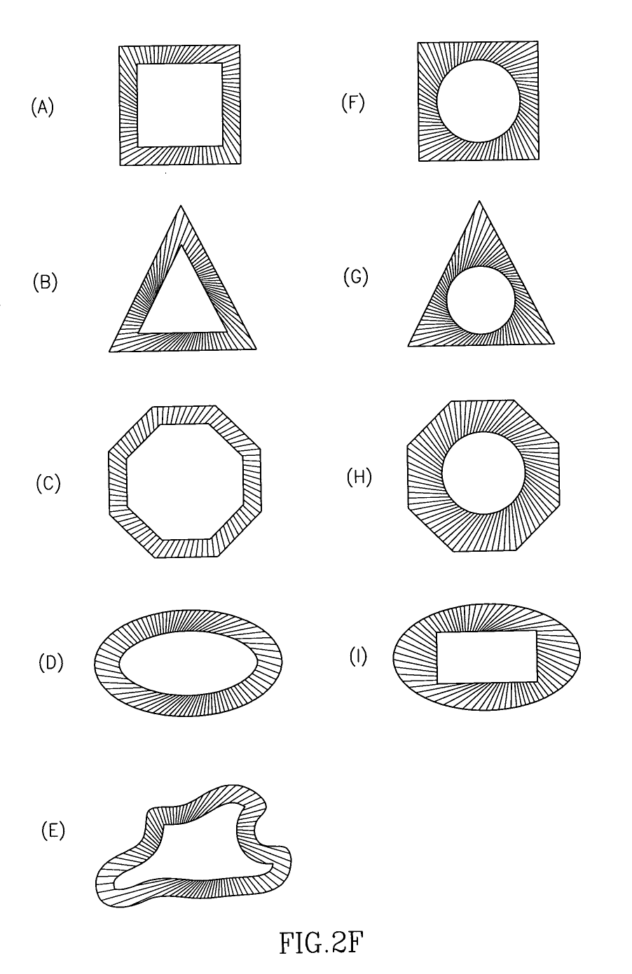

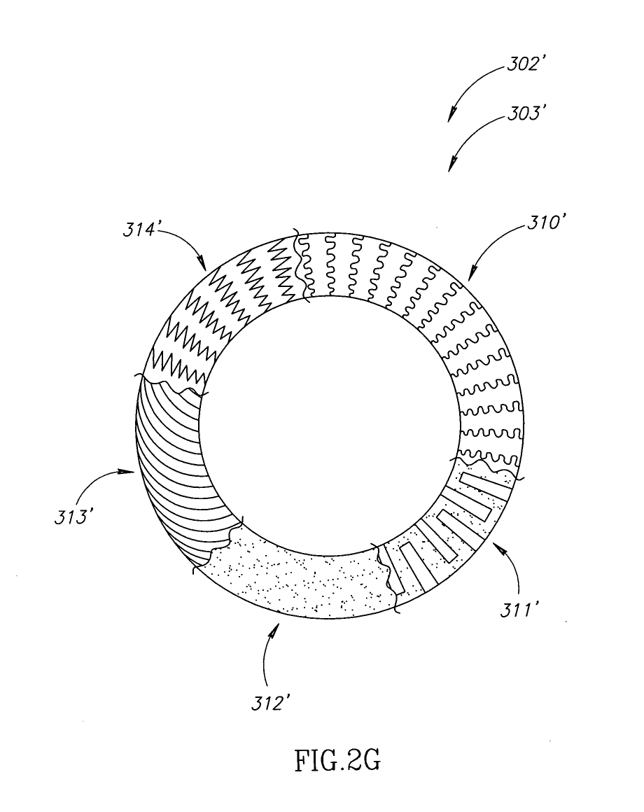

Reference is made to FIGS. 2A and 2B, which schematically show a face view of filter element 103 shown in FIG. 1 and a cross-sectional view A-A of filter element 103, in accordance with an embodiment of the invention. Reference is also made to FIG. 1. Filter element 103 is shown as an annular shaped disk with an opening 111 in the center. For convenience hereinafter filter element 103 may also be referred to as filter disk or disk. Disk 103 comprises v-shaped channels 152 on both sides of the disk, and is adapted to be tightly stacked one disk on top of another. An outer perimeter 150 forms an outer boundary of disk 103 and inner perimeter forms a boundary with an opening 111 centrally located in the disk. Optionally, opening 111 may be eccentrically located. When tightly stacked in filter 102, openings 111 comprise inner chamber 110.

In accordance with an embodiment of the invention, channels 152 slantedly (non-radially) extend from outer perimeter 150 towards inner perimeter 151. Channels 152 are oriented in a general direction such that flow of filter fluid 121 through the channels maintains a same general direction as flow of contaminated fluid 120, for example counterclockwise as shown. Alternatively, channels 152 may be oriented such that flow of filter fluid 121 is in a general clockwise direction for flow of contaminated fluid 120 in a clockwise direction

In accordance with an embodiment of the invention, channel dimensions are of a uniform depth h, measured from a flat surface 153 between channels 152, and a bottom 154 of the channel; and of a variable width w which is at a maximum at outer perimeter 150, and decreases as channel 152 approaches inner perimeter 151. Optionally, channel 152 may increase in width w from outer perimeter 150 to a predetermined point along a length of the channel, and then w decreases from the point onwards towards inner perimeter 151. Optionally, width w may be uniform along the length of channel 152. In some embodiments of the invention, the channel dimension may vary from channel to channel, or from some channels to other channels, or any combination thereof, either on one side of disk 103, or optionally, on both sides. In FIG. 2B, the two sides of disk 103 are shown as mirror images of one another, that is, flat surfaces 153 and channels 152 on one side of the disk are aligned with those on the other side of the disk. Optionally, flat surfaces 153 and channels 152 on one side of disk 103 may not be aligned with those on the other side of the disk.

Reference is made to FIG. 2C, which schematically shows a face view of a filter disk 203, comprised in a filter 202 in accordance with some embodiments of the invention. Filter 202 may be the same or substantially similar to filter 102 shown in FIG. 1. Disk 203 comprises channels 252, an outer perimeter 250, an inner perimeter 251, and an opening 211, the same or substantially similar to that shown in FIG. 1 at 152, 150, 151 and 111. Additionally, disk 203 comprises one or more support points 255 on one side, and optionally on a second side. The support points may be round as shown, although they may optionally have other shapes, and may be uniformly, or optionally non-uniformly, distributed throughout either one or both sides of disk 203. Support points 255 may optionally be associated with a manufacturing process of disk 203.

Reference is made to FIG. 2D, which schematically shows a face view of a filter disk 303 comprised in a filter 302, in accordance with some embodiments of the invention. Filter 302 may be the same or substantially similar to filter 102 shown in FIG. 1. Disk 303 comprises channels 352, an outer perimeter 350, an inner perimeter 351, and an opening 311, the same or substantially similar to that shown in FIG. 1 at 152, 150, 151 and 111. A variation from disk 103 is that channels 352 do not extend to inner perimeter 351. Instead, channels 352 extend to a flat surface area 355 peripherally located between inner perimeter 351 and channels 352. In some embodiments of the invention, disk 303 may comprise one or more support points, the same or substantially similar to that shown in FIG. 2C at 255. The support points may be located among channels 352, similar to support points 255 in FIG. 2C, and/or located in flat surface area 355.

In some embodiments of the invention, disk 103 may comprise channels 152 only on one side, or optionally other types of channel shapes on one side or both sides of the disk. Additionally or alternatively, the surface on one side, or optionally, both sides, may have a rough texture. Non-limiting, exemplary filtering elements comprising different cross-sections, A through E, are schematically shown in FIG. 2E. For example, A comprises a disk with v-shaped channels only on one side; B comprises rounded channels on both sides; C comprises rough surfaces on both sides; D comprises rounded channels on one side; E comprises flat-bottom channels on both sides.

In some embodiments of the invention, disk 103 may comprise other shapes, such as elliptical, rectangular shapes, square, regular polygonal shapes, or irregular shapes including irregular polygonal shapes. Furthermore, opening 111 may have other shapes, for example, elliptical, rectangular shapes, square, regular polygonal shapes, or irregular shapes including irregular polygonal shapes. Non-limiting, exemplary filtering elements comprising different shapes, A through I, and further comprising different shaped openings, are schematically shown in FIG. 2F. For example, A comprises a square shaped filter element with a square shaped opening; B comprises a triangular shaped filter element with a triangular shaped opening, C comprises an octagonal shaped filter element with an octagonal shaped opening; D comprises an elliptical shaped filter with an elliptical shaped opening; E comprises an irregular shaped filter with an irregular shaped opening; F comprises a square shaped filter with a circular shaped opening; G comprises a triangular shaped filter with a circular shaped opening; H comprises an octagonal shaped filter with a circular opening; I comprises an elliptical shaped filter with a rectangular shaped opening.

Reference is made to FIG. 2G, which schematically shows a face view of an exemplary filter disk 303′ comprised in a filter 302′, in accordance with some embodiments of the invention. Filter 302′ may be the same or substantially similar to filter 102 shown in FIG. 1. Disk 303′ may comprise channels which are shaped in different patterns, and/or surfaces with different textures, or any combination thereof. For example, disk 303′ comprises channels shaped in a zigzag pattern with curved corners, as shown at 310′; or channels shaped in a zigzag pattern with sharp corners, as shown at 314′; or channels shaped in a curved pattern, as shown at 313′; or a flat surface with prism-shaped protrusions randomly, or optionally non-randomly, distributed throughout the disk surface, as shown at 312′; or a textured surface as shown at 312′ with recessed flat surfaces on the disk side, or optionally protruding flat surfaces, the flat surfaces distributed so as to form a labyrinth-like configuration, as shown at 311′; or any combination thereof. Optionally, the channels shown in 310′ and 314′ may be radially oriented, or optionally, non-radially oriented. Additionally or alternatively, the channels may be oriented in essentially any direction. Optionally, the flat surfaces shown in 311′ may be oriented in essentially any direction.

In some embodiments of the invention, disk 303′ may comprise channels only on one side, or optionally other types of channel shapes and patterns on one side or both sides of the disk. Additionally or alternatively, the surface on one side, or optionally, both sides, may have a rough texture. Additionally or alternatively, disk 303′ may comprise other shapes, such as elliptical, rectangular shapes, square, regular polygonal shapes, or irregular shapes including irregular polygonal shapes. Optionally, disk 303′ may comprise an opening which may have other shapes, for example, elliptical, rectangular shapes, square, regular polygonal shapes, or irregular shapes including irregular polygonal shapes.

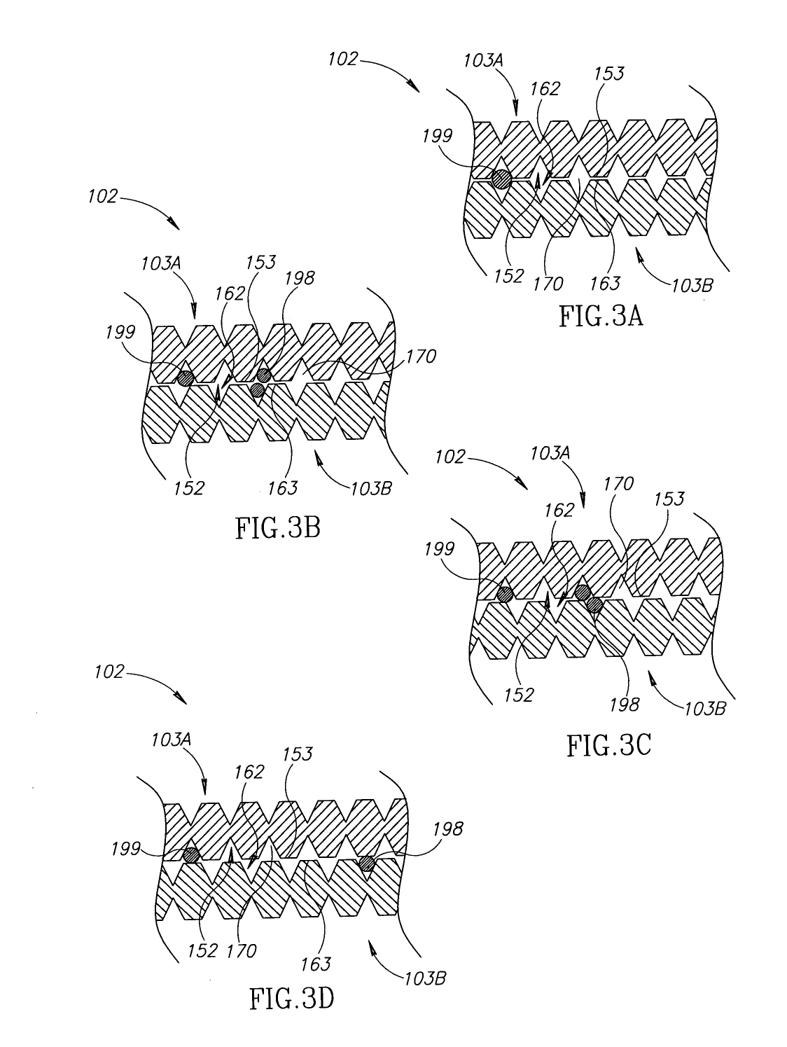

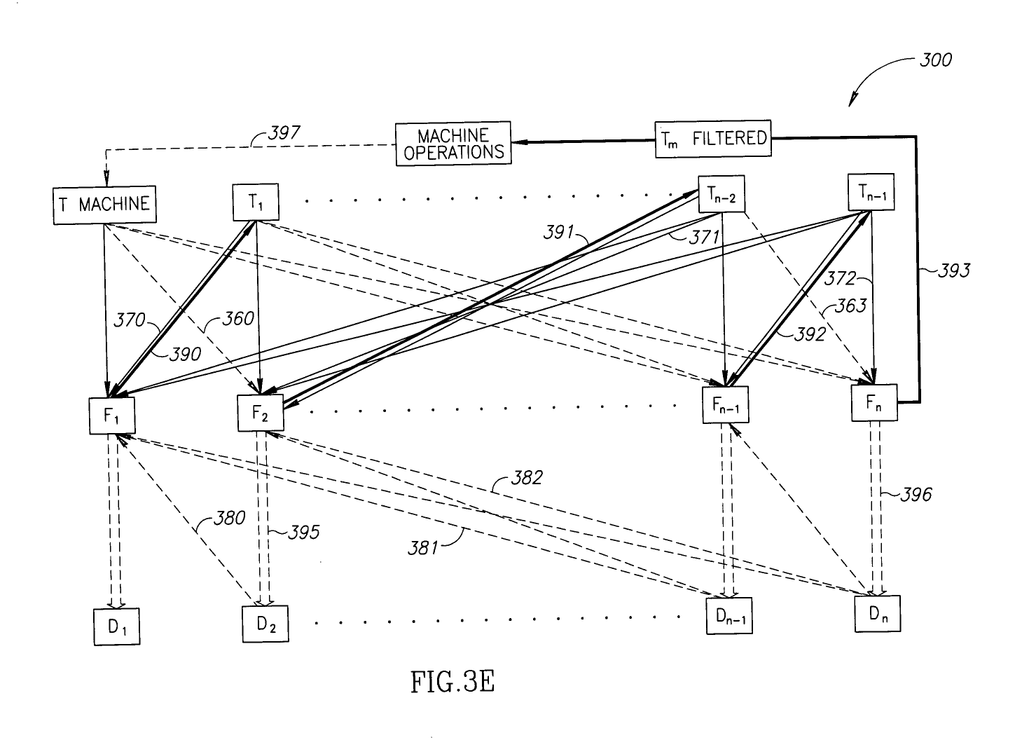

Reference is made to FIGS. 3A, 3B, 3C, and 3D which schematically show sectional views of exemplary channels 170, formed between two adjacent disks 103 shown in FIG. 1, in accordance with an embodiment of the invention. Reference is also made to FIGS. 1, 2A and 2B. For explanatory purposes two adjacent disks 103 may be designated as disk 103A and disk 103B.

Disks 103 are tightly stacked in filter 102 such that channels 152, comprised in a side of first disk 103A, may partially, or fully, align with channels 162 and/or flat surfaces 163 in an adjoining side of second disk 103B. Alternatively, channels 162, comprised in a side of second disk 103B, may partially, or fully, align with channels 152 and/or flat surfaces 153 in an adjoining side of first disk 103A. In accordance with an embodiment of the invention, partial, or full, alignment of channels 152 and/or flat surfaces 153 with channels 162 and/or flat surfaces 163 respectively, result in the formation of conduits 170 between disks 103A and 103B. Conduits 170 are adapted to allow through the flow of filter fluid 121 from outer perimeter 150 to opening 111, and are further adapted to trap particles 199 contaminating filter fluid 121, as the filter fluid flows through the conduit. Conduits 170 are additionally adapted to restrict the entry of relatively large particles contaminating contaminated fluid 120 into the conduit.

The range of sizes of particles 199 trapped by conduits 170 is dependent, among others, on the cross-sectional characteristics of the conduits, the cross-sectional characteristics varying according to the channel dimensions and the type of alignment between channels 152 and 162. For example, FIG. 3A illustrates a condition of full alignment between channels 152 and 162, and between flat surfaces 153 and 163, respectively. FIGS. 3B and 3C illustrate conditions of partial alignment between channels 152 and 162, flat surfaces 153 and 163 partially aligning with channels 162 and 152, respectively. In FIG. 3D for example, there is full alignment between channels 152 and flat surfaces 163, and between channels 162 and flat surfaces 153, respectively. Between any two disks 103, there may be a plurality of conduits 170 with different cross-sectional characteristics as shown, or other variations thereof, the conduits adapted to trap particles 199 of different sizes and shapes. Furthermore, a single conduit 170 may be adapted to trap particles 199 of different sizes, this due to a decreasing cross-sectional size in conduit 170 as the conduit nears opening 111. Smaller particles are first trapped in conduit sections closer to opening 111 and larger particles are later trapped in conduit sections closer to outer perimeter 150.

In accordance with an embodiment of the invention filter 102 is adapted to filter particles 199 of different size ranges in contaminated fluid 120. Filter 102 comprises a stack of disks 103 of channel dimensions such that conduits 170 formed by the alignment of channels and/or flat surfaces trap particles of a first size range. Replacing filter 102 with a second filter comprising a stack of filtering disks 103 of different channel dimensions provides for filtering particles 199 of a second size range. Optionally, replacing a stack of filtering disks 103 in filter 102 with a second stack of filtering disks of different channel dimensions provides for filtering particles of a second size range using filter 102.

Reference is made to FIG. 3E, which schematically shows an algorithmic flow diagram for filtering and backwash operations in a filtering device 300 adapted to filter contaminated fluid using different filter grades, in accordance with an embodiment of the invention. The filtering device comprises “n” serially-connected filtering devices shown as F₁, F₂ . . . Fₙ₋₁, and Fₙ; the filter grade of the devices successively decreasing from F₁ with a largest filter grade, to a smallest filter grade at Fₙ. Each filtering device, for example F₂, may comprise a single filter device of a predetermined filter grade, or may comprise a plurality of parallelly connected filtering devices of the same filter grade. Associated with each filtering device, F₁, F₂ . . . Fₙ₋₁, and Fₙ, is a clean fluid produced by each device and shown as T₁, T₂ . . . Tₙ₋₁, and T_{mFiltered}, respectively, and indicated by thick solid arrows, for example, arrows 390-393. Furthermore, associated with each filtering device, F₁, F₂ . . . Fₙ₋₁, and Fₙ, is a flushing fluid produced by each device and shown as D₁, D₂ . . . Dₙ₋₁, and Dₙ, respectively, and indicated by thick hatched arrows, for example, arrow 395 and 396. Filtering operations are indicated in the figure by hatched (short) arrows, such as, for example, arrow 360. Backwash operations using clean fluid are shown by solid arrows, such as, for example, arrow 370. Backwash operations using flushing fluid are shown by hatched (long) arrows, such as, for example, arrow 380.

In accordance with an embodiment of the invention, clean fluids produced by a filter of a particular filter grade may be filtered by one or more filter devices comprising smaller filter grades. In device 300, clean fluid T₁ produced by device F₁, comprises contaminating particles of a smaller size than the filter grade of F₁. Clean fluid T₁ may be further filtered by filtering devices comprising smaller filter grades than F₁, that is, by devices F₂ . . . Fₙ₋₁, or Fₙ, as shown by the hatched (small) arrows, such as for example arrows 360 and 363, leading from T₁ to F₂ . . . Fₙ₋₁, and Fₙ. Clean fluid T₂ produced by device F₂ comprises contaminating particles of a smaller size than the filter grade of F₂. Clean fluid T₂ may be further filtered by filtering devices comprising smaller filter grades than F₁, that is, by devices F₃ (not shown) . . . Fₙ₋₁, or Fₙ, as shown by the hatched (small) arrows, such as for example arrow 361, leading from T₂ to Fₙ₋₁, and Fₙ. Clean fluid Tₙ₋₂ may be further filtered by filtering devices comprising smaller filter grades than Fₙ₋₁, that is, by device Fₙ, as shown by the hatched (small) arrow, such as for example arrow 363, leading from Tₙ₋₂ to Fₙ.

In accordance with an embodiment of the invention, clean fluids produced by a filter of a particular filter grade may be used for backwash operations in filters of the same filter grade and/or larger filter grades. In filter device 300, clean fluid T₁ may be used for backwash operations in F₁ as shown by the solid arrow leading from Tᵢ to F₁. Clean fluid T₂ may be used for backwash operations in F₂, and may also be used for backwash operations in F₁, as shown by solid arrows, for example, arrow 370, leading from T₂ to F₁ and F₂. Clean fluid Tₒ₋₂ may be used for backwash operations in Fₙ₋₁, and may also be used for backwash operations in filter devices F₁, F₂ . . . Fₙ₋₂ (not shown), as shown by solid arrows, for example arrow 371, leading from Tₙ₋₂ to F₁, F₂ . . . Fₙ₋₁ Clean fluid Tₙ₋₁ may be used for backwash operations in Fₙ, and may also be used for backwash operations in filter devices F₁, F₂ . . . Fₒ₋₁, as shown by solid arrows, for example arrow 372, leading from Tₙ₋₁ to F₁, F₂ . . . Fₙ.

In accordance with an embodiment of the invention, flushing fluids produced by a backwash operation in a filter of a particular filter grade may be used for backwash operations in filters of larger filter grades. In filter device 300, flushing fluid D₂ may be used for backwash operations in F₁ as shown by the hatched (large) arrow 380 leading from D₂ to F₁. Flushing fluid Dₙ₋₁ may be used for backwash operations in filter devices F₁, F₂ . . . Fₙ₋₂ (not shown), as shown by hatched arrows, for example arrow 381, leading from Dₙ₋₁ to F₁ and F₂. Flushing fluid Dₙ may be used for backwash operations in filter devices F₁, F₂ . . . Fₙ₋₁, as shown by hatched arrows, for example arrow 382, leading from Dₙ to F₁, F₂ . . . Fₙ₋₁.

The algorithm may be further described by the following table:

| Function | Relationship | Example |
|---|---|---|
| Filtering | Tₙ₋₂ => Fₙ | T₁ => F_{2,,} T₂ => F₅ |
| Backwash | Tₙ₋₁ => Fₙ | T₃ => F_{2,,} T₂ => F₂ |
| Backwash | Dₙ₊₁ => Fₙ | D₃ => F_{2,} D₅ => F₂ |

In some embodiments of the invention, a clean fluid T_{mFiltered} 393 from filter device Fₙ, may be used for machining operations. A fluid T_{machine} 397, comprising particles from the machining operation, may be used for backwash operations in filter device F₁.

FIG. 3E describes one example of possible algorithmic flow for filtering and backwash operations in filtering systems. Other algorithms may be applied for filtering and backwash operations in other, same or similar filtering systems, according to embodiments of the invention.

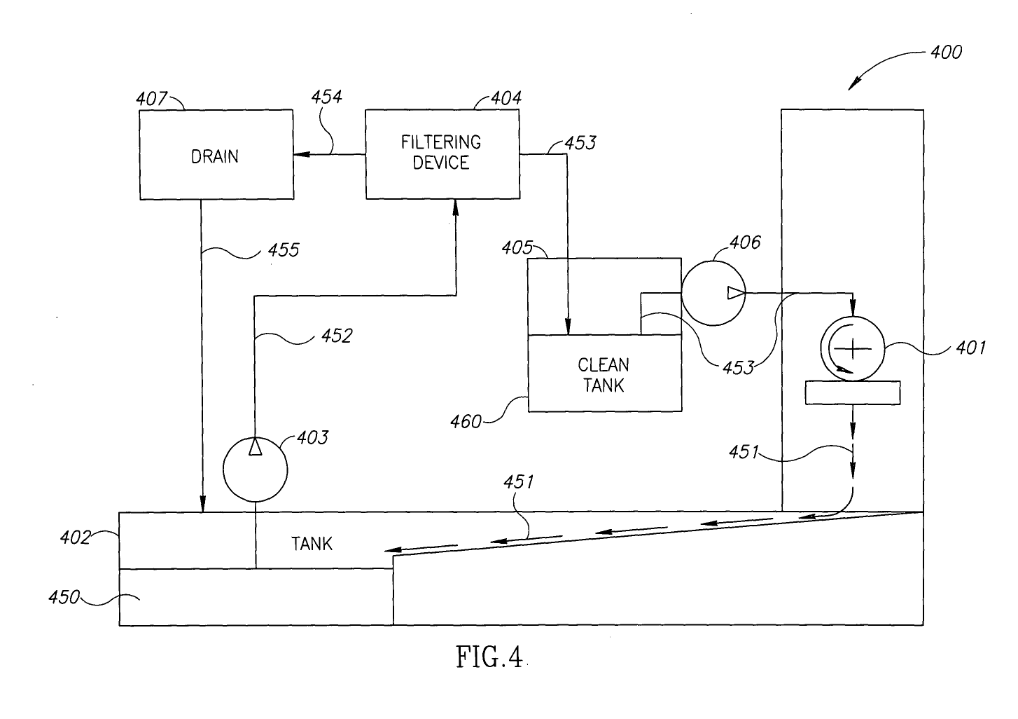

Reference is made to FIG. 4, which schematically shows a flow diagram of an exemplary filtering system 400 adapted to perform full-stream filtration of contaminated fluids for machining equipment 401, in accordance with an embodiment of the invention. Machining equipment 401 may comprise any power-driven machine tools, such as, for example, lathing machinery, milling machinery, grinding machinery, cutting machinery, and drilling machinery, adapted to shape a work piece made of metal and/or other materials by material removal in the form of chips. Machining equipment 401 may include relatively simple equipment controlled by an operator, and/or advanced automatic equipment such as CNC equipment. Optionally, machining equipment 401 may be adapted to perform electrical discharge machining (EDM), electro-chemical erosion, laser, or water jet cutting to shape work pieces. Machining equipment 401 is further adapted to use oil and/or emulsions (fluid) as lubricants and/or coolants for machining equipment components, and/or the work piece. Optionally, the fluid may be used for cleaning the work area, including tooling components in machining equipment 401, and/or the work piece.

Filtering system 400 comprises one or more contaminated fluid collection tanks 402, one or more filtering devices 404, one or more drains 407, one or more contaminated fluid pumps 403, one or more clean fluid tanks 405, and one or more clean fluid pumps 406. Contaminated fluid collection tank 402 is adapted to collect contaminated fluid 450 resulting from machining processes performed by machining equipment 401, a direction of flow of a contaminated fluid 450 indicated by arrows 451. Pump 403 is adapted to pump, at a relatively low pressure, contaminated fluid 450 from collection tank 402 to filtering device 404, a direction of contaminated fluid flow shown by arrow 452. Pump 403 may be further adapted to automatically initiate pumping of contaminated fluid 450 upon receiving a signal from a sensor, optionally comprised in collection tank 402, indicating that the contaminated fluid has reached a predetermined high level in the collection tank.

Filtering device 404, which may be the same or substantially similar to filtering device 100 shown in FIG. 1A, is adapted to receive contaminated fluid 450 pumped by pump 403 from collection tank 402, and is further adapted to produce a clean fluid 460 (shown in clean tank 405) by filtering particulate contamination from the contaminated fluid. Optionally, filtering device 404 may be the same or substantially similar to filtering device 100A in FIG. 1B. In accordance with an embodiment of the invention, filtering device 404 may comprise a plurality of filtering devices 404, for example, 2, 3, 4, 5, 6, 7, 8, 9, 10, or more. The plurality of filtering devices 404 may be serially and/or parallelly connected, or any combination thereof. Filtering device 404 may be adapted to filter particles of one size range, or may optionally be adapted to filter particles of different size ranges by serially connecting filtering devices of successively decreasing filter grades, similar to filtering device 300 in FIG. 3E. Optionally, filtering device 404 may be connected, using proper connection means, to other types of filters known in the art, for example, hydrocyclone (cyclone) filter, paper gravity filter, centrifuge filter, drum filter, candle filter and precoated filter, and/or paper and/or polymeric cartridge filtering, among others.

Clean fluid 460, a direction of flow of which is indicated by arrow 453, flows from filtering device 404 to clean fluid tank 405. Clean tank 405 is adapted to receive clean fluid 460 from filtering device 404, and is further adapted to store the clean fluid for use by machining equipment 401. Clean fluid flow may be gravity based, although in some embodiments of the invention, one or more pumps may be connected to outlet 107 in filtering device 100, or optionally to outlet 106A in filtering device 100A, for pumping clean fluid 460 to clean tank 405. Optionally, clean tank 405 may be further adapted to send a signal to pump 403, automatically initiating the pump when clean fluid 460 in tank 405 is below a predetermined low level. Optionally, clean tank 405 may be further adapted to send a signal to pump 403 automatically deactivating the pump when clean fluid 460 in tank 405 is at or above a predetermined high level. Optionally, clean tank 405 may be further adapted to send an activation signal and/or deactivation signal to any one pump, or any combination of pumps, comprised in filtering system 400. In some embodiments of the invention, clean tank 405 may be comprised inside machining equipment 401.

Connected to clean tank 405 is pump 406, which is adapted to pump clean fluid 460 from clean tank 405 to machining equipment 401, the direction of clean fluid flow shown by arrow 453. Pump 406 may be further adapted to automatically initiate pumping of clean fluid 460 upon receiving a signal from a sensor, optionally comprised in clean fluid tank 405, indicating that the clean fluid has reached a predetermined high level in the clean tank. Optionally, pump 406 may be further adapted to automatically initiate pumping of clean fluid 460 upon receiving a signal from machining equipment 401.

Filtering device 404 is connected to drain 407, which is adapted to receive flushing fluid following backwash operation of the filtering device. A direction of flow of the flushing fluid is shown by arrow 454. In some embodiments of the invention, drain 407 may be connected to contaminated fluid collection tank 402 such that the flushing fluid is recycled into contaminated fluid 450, as shown by arrow 455, for example, after drying of chips in the flushing fluid. Optionally, drain 407 may include a tank and/or any system adapted to clean fluids, for example, a system having a filter, a cyclone, a centrifuge, a precipitation capability or the like. Optionally, the drain may be connected to a briquetting machine (not shown) adapted to briquette the particulate contaminants in the flushing fluid following backwash. Optionally, the flushing fluid may be used for backwash operation in filter device 404. Additionally or alternatively, the flushing fluid may flow into clean tank 460, if the fluid is substantially contaminate free. Optionally, the flushing fluid may be removed from filtering system 400 for other applications and/or uses.

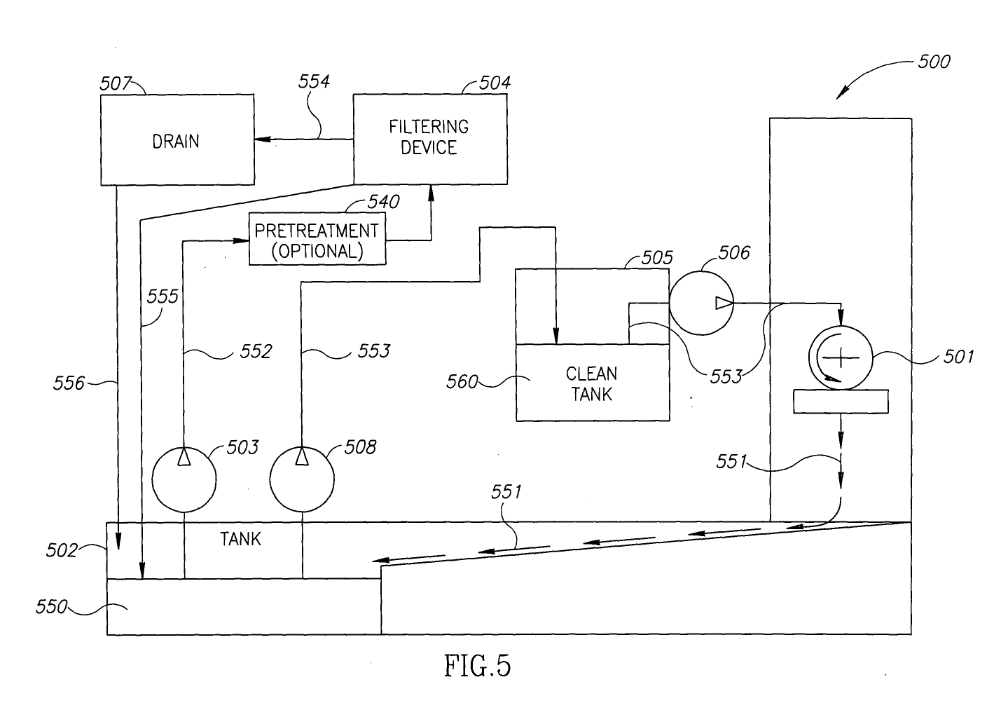

Reference is made to FIG. 5, which schematically shows a flow diagram of an exemplary filtering system 500 adapted to perform side-stream filtration of contaminated fluids for machining equipment 501, in accordance with an embodiment of the invention. Machining equipment 501 may be the same or substantially similar to machining equipment 401 shown in FIG. 4.

Filtering system 500 comprises one or more contaminated fluid collection tanks 502, one or more filtering devices 504, one or more drains 507, one or more contaminated fluid pumps 503, one or more mixed fluid pumps 508, one or more clean fluid tanks 505, and one or more clean fluid pumps 506. Contaminated fluid collection tank 502 is adapted to collect contaminated fluid 550 resulting from machining processes performed by machining equipment 501, a direction of flow of contaminated fluid 550 indicated by arrows 551. Pump 503 is adapted to pump at a flow rate of between 5%-20% of a predetermined flow rate capacity of machining equipment 501, for example 10%, contaminated fluid 550 from collection tank 502 to filtering device 504, a direction of contaminated fluid flow shown by arrow 552. Pump 503 may be further adapted to automatically initiate pumping of contaminated fluid 550 upon receiving a signal from a sensor, optionally comprised in collection tank 502, indicating that the contaminated fluid has reached a predetermined level in the collection tank.

Optionally, contaminated fluid 550 may be pretreated before reaching filtering device 504. A pretreatment device 540 may comprise for example, the use of agglomeration equipment; magnets, such as electro-magnets; chemical treatment; ultrasound treatment and other components; equipment such as fluid make-up system (water treatment, concentrate dosing station, level switch); tramp oil separator; and other filtration method such as hydrocyclone, centrifuge, paper gravity, drum filter, candle filter, and/or cartridge filter; or any combination thereof.

Filtering device 504, which may be the same or substantially similar to filtering device 100 shown in FIG. 1A, is adapted to receive contaminated fluid 550 pumped by pump 503 from collection tank 502, and is further adapted to produce a clean fluid by filtering particulate contamination from the contaminated fluid. Optionally, filtering device 504 may be the same or substantially similar to filtering device 100A in FIG. 1B. In accordance with an embodiment of the invention, filtering device 504 may comprise a plurality of filtering devices 504, for example, 2, 3, 4, 5, 6, 7, 8, 9, 10, or more. The plurality of filtering devices 504 may be serially and/or parallelly connected, or any combination thereof. Filtering device 504 may be adapted to filter particles of one size range, or may optionally be adapted to filter particles of different size ranges by serially connecting filtering devices of successively decreasing filter grades, similar to filtering device 300 in FIG. 3E. Optionally, filtering device 504 may be connected, using proper connection means, to other types of filters known in the art, for example, hydrocyclone (cyclone) filter, paper gravity filter, centrifuge filter, drum filter, candle filter and precoated filter, and/or paper and/or polymeric cartridge filtering, among others.

The clean fluid, a direction of flow of which is indicated by arrow 555, flows from filtering device 504 back into contaminated fluid collection tank 502, where the clean fluid mixes with the contaminated fluid remaining in collection tank 502, producing a mixed fluid (shown as 560 in clean tank 505). Clean fluid flow may be gravity based, although in some embodiments of the invention, one or more pumps may be connected to outlet 107 in filtering device 100, or optionally to outlet 106A in filtering device 100A, for pumping clean fluid to collection tank 502.

Pump 508 is adapted to pump mixed fluid 560 from collection tank 502 to clean tank 505, a direction of mixed fluid flow shown by arrow 553. Mixed fluid 560 may be pumped, at least, at a flow rate capacity corresponding with a predetermined flow rate capacity required by machining equipment 501. Pump 508 may be further adapted to automatically initiate pumping of mixed fluid 560 upon receiving a signal from a sensor, optionally comprised in collection tank 502, indicating that the contaminated fluid has reached a predetermined high level in the collection tank.

Clean tank 505 is adapted to receive mixed fluid 560 from collection tank 502 and is further adapted to store the mixed fluid for use by machining equipment 501. Optionally, clean tank 505 may be further adapted to send a signal to pump 508, automatically initiating the pump when mixed fluid 560 in tank 505 is below a predetermined low level. Optionally, clean tank 505 may be further adapted to send a signal to pump 508 automatically deactivating the pump when mixed fluid 560 in tank 505 is at or above a predetermined high level. Optionally, clean tank 505 may be further adapted to send an activation signal and/or deactivation signal to any one pump, or any combination of pumps, comprised in filtering system 500. In some embodiments of the invention, clean tank 505 may be comprised inside machining equipment 501.

Connected to clean tank 505 is pump 506, which is adapted to pump mixed fluid 560 from clean tank 505 to machining equipment 501, the direction of clean fluid flow shown by arrow 553. Pump 506 may be further adapted to automatically initiate pumping of mixed fluid 560 upon receiving a signal from a sensor, optionally comprised in clean fluid tank 505, indicating that the mixed fluid has reached a predetermined high level in the clean tank. Optionally, pump 506 may be further adapted to automatically initiate pumping of mixed fluid 560 upon receiving a signal from machining equipment 501.

Filtering device 504 is connected to drain 507, which is adapted to receive flushing fluid following backwash operation of the filtering device. A direction of flow of the flushing fluid is shown by arrow 554. In some embodiments of the invention, drain 507 may be connected to contaminated fluid collection tank 502 such that the flushing fluid is recycled into contaminated fluid 550, as shown by arrow 556, for example, following drying of chips in the flushing fluid. Optionally, drain 507 may include a tank and/or any system adapted to clean fluids, for example, a system having a filter, a cyclone, a centrifuge, a precipitation capability or the like. Optionally, the drain may be connected to a briquetting machine (not shown) adapted to briquette particulate contaminants in the flushing fluid following backwash. Optionally, the flushing fluid may be removed from filtering system 500 for other applications and/or uses.

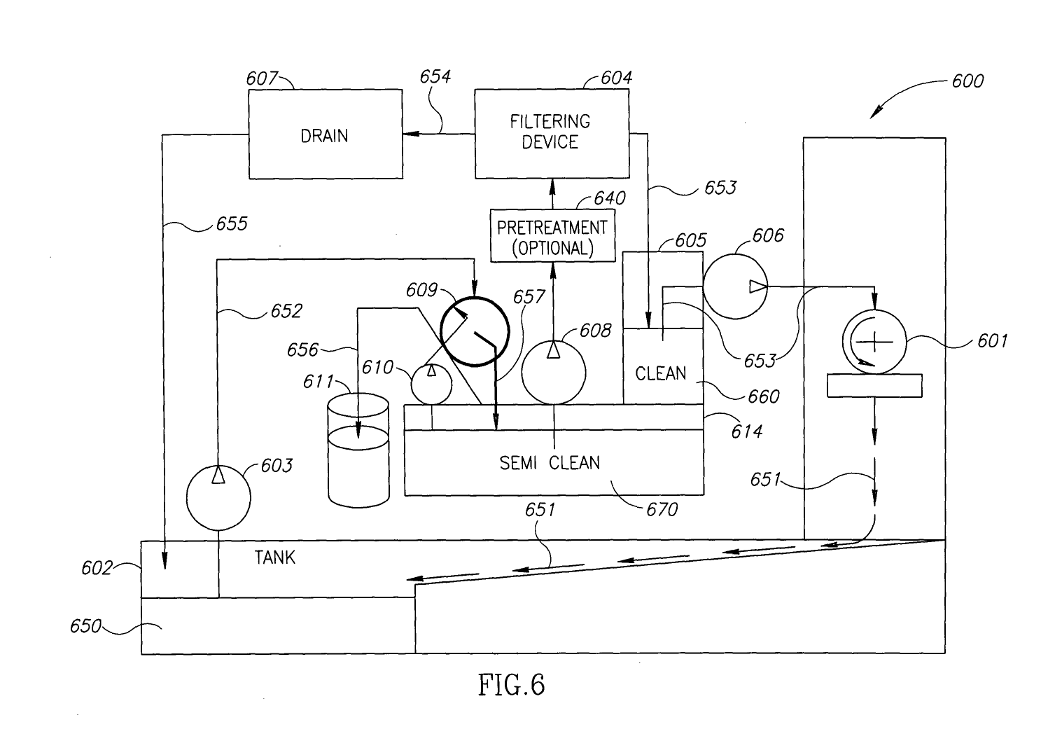

Reference is made to FIG. 6, which schematically shows a flow diagram of an exemplary filtering system 600 adapted to perform pre-filtered, full-stream filtration of contaminated fluids for machining equipment 601, in accordance with an embodiment of the invention. Machining equipment 601 may be the same or substantially similar to machining equipment 401 shown in FIG. 4.

Filtering system 600 comprises one or more contaminated fluid collection tanks 602, one or more filtering devices 604, one or more drains 607, one or more contaminated fluid pumps 603, one or more clean fluid tanks 605, one or more clean pumps 606, one or more pre-filters 609, one or more pre-filter backwash pumps 610, one or more pre-filter drains 611, one or more semi-clean liquid collection tanks 614, and one or more semi-clean liquid pumps 608. Contaminated liquid collection tank 602 is adapted to collect contaminated fluid 650 resulting from machining processes performed by machining equipment 601, a direction of flow of contaminated fluid 650 indicated by arrows 651. Pump 603 is adapted to pump contaminated fluid 650 from collection tank 602 to pre-filter 609, a direction of contaminated fluid flow shown by arrow 652. Pump 603 may be further adapted to automatically initiate pumping of contaminated fluid 650 upon receiving a signal from a sensor, optionally comprised in collection tank 602, indicating that the contaminated fluid has reached a predetermined high level in the collection tank.

Pre-filter 609 may be adapted to partially filter the contaminated fluid and may comprise other types of filters known in the art, for example, hydrocyclone filter, paper gravity filter, centrifuge filter, drum filter, candle filter and precoated filter, and/or paper and/or polymeric cartridge filtering, among others. Optionally, pre-filter device 609 may comprise a plurality of similar pre-filters, or a combination of different pre-filters. A semi-clean fluid 670, a direction of flow of which is indicated by arrow 657, flows from pre-filter 609 to semi-clean fluid tank 614. Semi-clean tank 614 is adapted to receive semi-clean fluid 670 from pre-filter 609, and is further adapted to store the semi-clean fluid for further filtering by filtering device 604. Semi-clean fluid flow from pre-filter 609 to semi-clean collection tank 614 may be gravity based, although in some embodiments of the invention, one or more pumps may be connected to the pre-filter adapted to pump semi-clean fluid 670 to the semi-clean collection tanks. Optionally, semi-clean tank 614 may be further adapted to send a signal to pump 603, automatically initiating the pump when semi-clean fluid 670 in the semi-clean tank is below a predetermined low level. Optionally, semi-clean tank 614 may be further adapted to send a signal to pump 603, automatically deactivating the pump when semi-clean fluid 670 in semi-clean tank 614 is at or above a predetermined high level.

Pre-filter 609 is connected to drain 611, which is adapted to receive a flushing fluid following backwash operation of the pre-filter. A backwash pump 610 pumps the flushing fluid, which may optionally comprise a relative small quantity of semi-clean fluid 670, from semi-clean tank 614 through pre-filter 609 at a relatively high pressure sufficient to substantially remove particulate contaminants from the pre-filter. A direction of flow of the flushing fluid is shown by arrow 656. In some embodiments of the invention, drain 611 may be connected to contaminated fluid collection tank 602 such that the flushing fluid is recycled into contaminated fluid 650. Optionally, drain 611 may be connected to semi-clean tank 614. Optionally, drain 611 may be connected to a briquetting machine (not shown) adapted to briquette the particulate contaminants in the flushing fluid following backwash. Optionally, the flushing fluid may be removed from filtering system 600 for other applications and/or uses.

Filtering device 604, which may be the same or substantially similar to filtering device 100 shown in FIG. 1A, is adapted to receive semi-clean fluid 670 pumped by pump 608 from semi-clean fluid collection tank 614, a direction of flow of the semi-clean fluid indicated by arrow 655. Filtering device 604 is further adapted to produce a clean fluid 660 (shown in clean tank 605) by filtering particulate contamination from semi-clean fluid 670. Optionally, filtering device 604 may be the same or substantially similar to filtering device 100A in FIG. 1B. In accordance with an embodiment of the invention, filtering device 604 may comprise a plurality of filtering devices 604, for example, 2, 3, 4, 5, 6, 7, 8, 9, 10, or more. The plurality of filtering devices 604 may be serially and/or parallelly connected, or any combination thereof. Filtering device 604 may be adapted to filter particles of one size range, or may optionally be adapted to filter particles of different size ranges by serially connecting filtering devices of successively decreasing filter grades, similar to filtering device 300 in FIG. 3E. Optionally, filtering device 604 may be connected, using proper connection means, to other types of filters known in the art, for example, hydrocyclone (cyclone) filter, paper gravity filter, centrifuge filter, drum filter, candle filter and precoated filter, and/or paper and/or polymeric cartridge filtering, among others.

Optionally, semi-clean fluid 670 may be pretreated before reaching filtering device 604. A pretreatment device 640 may comprise, for example, the use of agglomeration equipment; magnets, such as electro-magnets, chemical treatment, ultrasound treatment and other components, equipment such as fluid make-up system (water treatment, concentrate dosing station, level switch), tramp oil separator, and other filtration method such as hydrocyclone, centrifuge, paper gravity, drum filter, candle filter, and/or cartridge filter; or any combination thereof.

Clean fluid 660, a direction of flow of which is indicated by arrow 653, flows from filtering device 604 to clean fluid tank 605. Clean tank 605 is adapted to receive clean fluid 660 from filtering device 604, and is further adapted to store the clean fluid for use by machining equipment 601. Clean fluid flow may be gravity based, although in some embodiments of the invention, one or more pumps may be connected to outlet 107 in filtering device 100, or optionally to outlet 106A in filtering device 100A, for pumping clean fluid 660 to clean tank 605. Optionally, clean tank 605 may be further adapted to send a signal to pump 608, automatically initiating the pump when clean fluid 660 in tank 605 is below a predetermined low level. Optionally, clean tank 605 may be further adapted to send a signal to pump 608, automatically deactivating the pump when clean fluid 660 in tank 605 is at or above a predetermined high level. Optionally, clean tank 605 may be further adapted to send a signal to pump 603, automatically activating or deactivating the pump according to predetermined levels of clean fluid 660 in the tank. Optionally, clean tank 605 may be further adapted to send an activation signal and/or deactivation signal to any one pump, or any combination of pumps, comprised in filtering system 600. In some embodiments of the invention, clean tank 605 may be comprised inside machining equipment 601.

Connected to clean tank 605 is pump 606, which is adapted to pump clean fluid 660 from clean tank 605 to machining equipment 601, the direction of clean fluid flow shown by arrow 653. Pump 606 may be further adapted to automatically initiate pumping of clean fluid 660 upon receiving a signal from a sensor, optionally comprised in clean fluid tank 605, indicating that the clean fluid has reached a predetermined high level in the clean tank. Optionally, pump 606 may be further adapted to automatically initiate pumping of clean fluid 660 upon receiving a signal from machining equipment 601.

Filtering device 604 is connected to drain 607, which is adapted to receive flushing fluid following backwash operation of the filtering device. A direction of flow of the flushing fluid is shown by arrow 654. In some embodiments of the invention, drain 607 may be connected to contaminated fluid collection tank 602 such that the flushing fluid is recycled into contaminated fluid 650, as shown by arrow 655, for example, after chips in the fluid are dried. Optionally, drain 607 may be connected to semi-clean tank 614, such that the flushing fluid is recycled into the semi-clean fluid 670. Optionally, drain 607 may include a tank and/or any system adapted to clean fluids, for example, a system having a filter, a cyclone, a centrifuge, a precipitation capability or the like. Optionally, the drain may be connected to a briquetting machine for briquetting of the contaminating part. Optionally, the flushing fluid may be removed from filtering system 600 for other applications and/or uses.

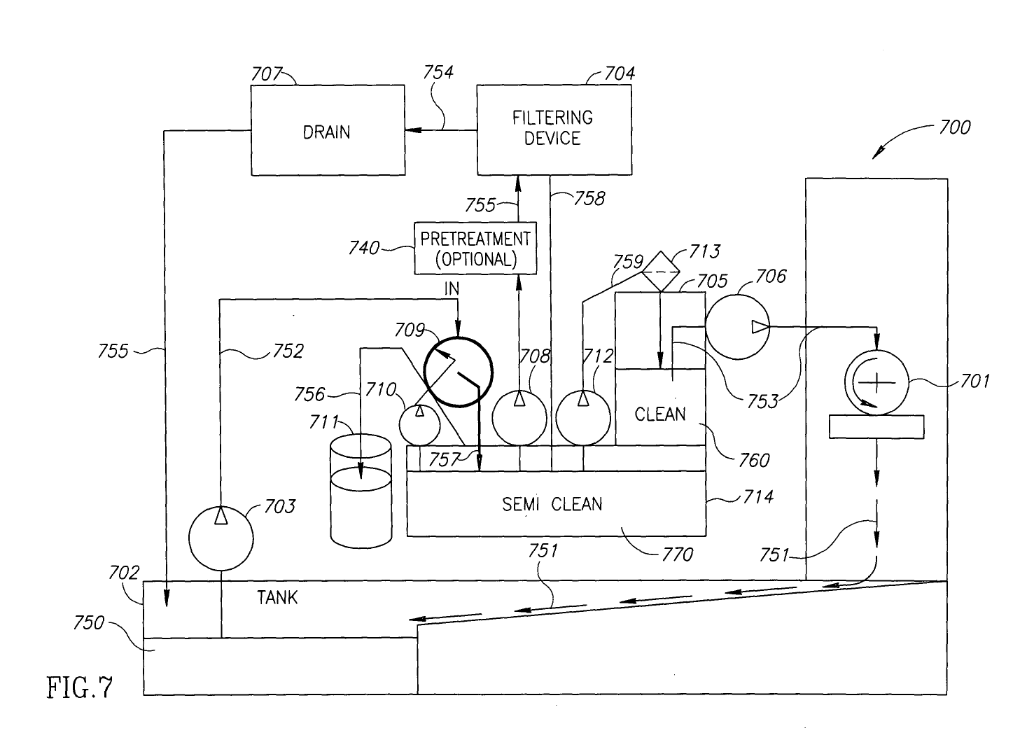

Reference is made to FIG. 7, which schematically shows a flow diagram of an exemplary filtering system 700 adapted to perform pre-filtered, side-stream filtration of contaminated fluids for machining equipment 701, and additionally comprising a polisher filter 713, in accordance with an embodiment of the invention. Optionally, filtering system 700 may not comprise a polisher filter 713. Machining equipment 701 may be the same or substantially similar to machining equipment 401 shown in FIG. 4.

Filtering system 700 comprises one or more contaminated fluid collection tanks 702, one or more filtering devices 704, one or more drains 707, one or more contaminated fluid pumps 703, one or more clean fluid tanks 705, one or more clean fluid pumps 706, one or more pre-filters 709, one or more pre-filter backwash pumps 710, one or more pre-filter drains 711, one or more semi-clean fluid collection tanks 714, one or more semi-clean fluid pumps 708, one or more mixed fluid pumps 712, and one or more cartridge (polisher) filters 713. Contaminated fluid collection tank 702 is adapted to collect contaminated fluid 750 resulting from machining processes performed by machining equipment 701, a direction of flow of contaminated fluid 750 indicated by arrows 751. Pump 703 is adapted to pump contaminated fluid 750 from collection tank 702 to pre-filter 709, a direction of contaminated fluid flow shown by arrow 752. Pump 703 may be further adapted to automatically initiate pumping of contaminated fluid 750 upon receiving a signal from a sensor, optionally comprised in collection tank 702, indicating that the contaminated fluid has reached a predetermined high level in the collection tank.

Pre-filter 709 may be adapted to partially filter the contaminated fluid and may comprise other types of filters known in the art, for example, hydrocyclone filter, paper gravity filter, centrifuge filter, drum filter, candle filter and precoated filter, and/or paper and/or polymeric cartridge filtering, among others. Optionally, pre-filter device 709 may comprise a plurality of similar pre-filters, or a combination of different pre-filters. A semi-clean fluid 770, a direction of flow of which is indicated by arrow 757, flows from pre-filter 709 to semi-clean fluid tank 714. Semi-clean tank 714 is adapted to receive semi-clean fluid 770 from pre-filter 709 for further filtering by filtering device 704. Semi-clean fluid flow from pre-filter 709 to semi-clean collection tank 714 may be gravity based, although in some embodiments of the invention, one or more pumps may be connected to the pre-filter adapted to pump semi-clean fluid 770 to the semi-clean collection tanks. Optionally, semi-clean tank 714 may be further adapted to send a signal to pump 703, automatically initiating the pump when semi-clean fluid 770 in the semi-clean tank is below a predetermined low level. Optionally, semi-clean tank 714 may be further adapted to send a signal to pump 703, automatically deactivating the pump when semi-clean fluid 770 in semi-clean tank 714 is at or above a predetermined high level.

Pre-filter 709 is connected to drain 711, which is adapted to receive a flushing fluid following backwash operation of the pre-filter. A backwash pump 710 pumps the flushing fluid, which may optionally comprise a relative small quantity of semi-clean fluid 770, from semi-clean tank 714 through pre-filter 709 at a relatively high pressure sufficient to substantially remove particulate contaminants from the pre-filter. A direction of flow of the flushing fluid is shown by arrow 756. In some embodiments of the invention, drain 711 may be connected to contaminated fluid collection tank 702 such that the flushing fluid is recycled into contaminated fluid 750. Optionally, drain 711 may be connected to semi-clean tank 714. Optionally, drain 711 may be connected to a briquetting machine (not shown) adapted to briquette the particulate contaminants in the flushing fluid following backwash. Optionally, the flushing fluid may be removed from filtering system 700 for other applications and/or uses.

Pump 708 is adapted to pump at a flow rate of between 5%-20% of a predetermined flow rate capacity of machining equipment 701, for example 10%, semi-clean fluid 770 from semi-clean tank 714 to filtering device 704, a direction of semi-clean fluid flow shown by arrow 755. Pump 703 may be further adapted to automatically initiate pumping of semi-clean fluid 770 upon receiving a signal from a sensor, optionally comprised in semi-clean tank 714, indicating that the contaminated fluid has reached a predetermined level in the collection tank.

Optionally, semi-clean fluid 770 may be pretreated before reaching filtering device 704. A pretreatment device 740 may comprise, for example, the use of agglomeration equipment; magnets, such as electro-magnets; chemical treatment; ultrasound treatment and other components; equipment such as fluid make-up system (water treatment, concentrate dosing station, level switch); tramp oil separator; and other filtration method such as hydrocyclone, centrifuge, paper gravity, drum filter, candle filter, and/or cartridge filter; or any combination thereof.

Filtering device 704, which may be the same or substantially similar to filtering device 100 shown in FIG. 1A, is adapted to receive semi-clean fluid 770 pumped by pump 708 from semi-clean tank 714, and is further adapted to produce a clean fluid by filtering particulate contamination from the semi-clean fluid. Optionally, filtering device 704 may be the same or substantially similar to filtering device 100A in FIG. 1B. In accordance with an embodiment of the invention, filtering device 704 may comprise a plurality of filtering devices 704, for example, 2, 3, 4, 5, 6, 7, 8, 9, 10, or more. The plurality of filtering devices 704 may be serially and/or parallelly connected, or any combination thereof. Filtering device 704 may be adapted to filter particles of one size range, or may optionally be adapted to filter particles of different size ranges by serially connecting filtering devices of successively decreasing filter grades, similar to filtering device 300 in FIG. 3E. Optionally, filtering device 704 may be connected, using proper connection means, to other types of filters known in the art, for example, hydrocyclone (cyclone) filter, paper gravity filter, centrifuge filter, drum filter, candle filter and precoated filter, and/or paper and/or polymeric cartridge filtering, among others.

The clean fluid, a direction of flow of which is indicated by arrow 758, flows from filtering device 704 back into semi-clean fluid collection tank 714, where the clean fluid mixes with the semi-clean fluid remaining in collection tank 702 producing a mixed clean fluid (shown as 760 in clean tank 705). Clean fluid flow may be gravity based, although in some embodiments of the invention, one or more pumps may be connected to outlet 107 in filtering device 100, or optionally to outlet 106A in filtering device 100A, for pumping clean fluid to semi-clean tank 714.

Pump 712 is adapted to pump mixed clean fluid 760 from semi-clean tank 714, to a cartridge filter 713 adapted to relatively finely filter the mixed clean fluid for use as polishing fluid. A direction of mixed clean fluid 760 flow is shown by arrow 759. Mixed clean fluid 760 may be pumped, at least, at a flow rate capacity corresponding with a predetermined flow rate capacity required by machining equipment 701. Pump 712 may be further adapted to automatically initiate pumping of mixed fluid 760 upon receiving a signal from a sensor, optionally comprised in semi-clean tank 714, indicating that the mixed clean fluid has reached a predetermined high level in the collection tank.

Clean tank 705 is adapted to receive a clean fluid 760 from cartridge filter 713 and is further adapted to store the mixed fluid for use by machining equipment 701. Optionally, clean tank 705 may be further adapted to send a signal to pump 712, automatically initiating the pump when clean fluid 760 in the tank is below a predetermined low level. Optionally, clean tank 705 may be further adapted to send a signal to pump 712 automatically deactivating the pump when clean fluid 760 in tank 705 is at or above a predetermined high level. Optionally, clean tank 705 may be further adapted to send an activation signal and/or deactivation signal to any one pump, or any combination of pumps, comprised in filtering system 700. In some embodiments of the invention, clean tank 705 may be comprised inside machining equipment 701.

Connected to clean tank 705 is pump 706, which is adapted to pump clean fluid 760 from clean tank 705 to machining equipment 701, the direction of clean fluid flow shown by arrow 753. Pump 706 may be further adapted to automatically initiate pumping of clean fluid 760 upon receiving a signal from a sensor, optionally comprised in clean fluid tank 705, indicating that the clean fluid has reached a predetermined high level in the clean tank. Optionally, pump 706 may be further adapted to automatically initiate pumping of clean fluid 760 upon receiving a signal from machining equipment 701.

Filtering device 704 is connected to drain 707, which is adapted to receive flushing fluid following backwash operation of the filtering device. A direction of flow of the flushing fluid is shown by arrow 754. In some embodiments of the invention, drain 707 may be connected to contaminated fluid collection tank 702 such that the flushing fluid is recycled into contaminated fluid 750, as shown by arrow 755, for example, following drying of chips in the flushing fluid. Optionally, drain 707 may be connected to semi-clean tank 714 such that the flushing fluid is recycled into the mixed clean fluid 770. Optionally, drain 707 may include a tank and/or any system adapted to clean fluids, for example, a system having a filter, a cyclone, a centrifuge, a precipitation capability or the like. Optionally, the drain may be connected to a briquetting machine (not shown) adapted to briquette particulate contaminants in the flushing fluid following backwash. Optionally, the flushing fluid may be removed from filtering system 700 for other applications and/or uses.

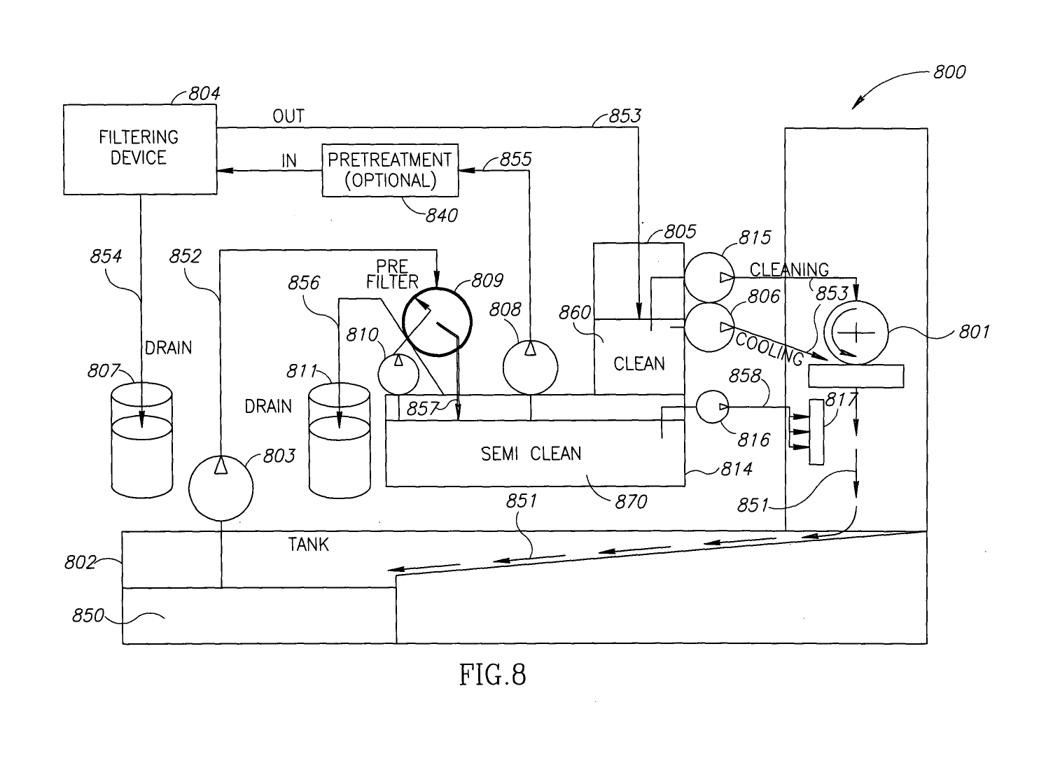

Reference is made to FIG. 8, which schematically shows a flow diagram of an exemplary filtering system 800 adapted to perform pre-filtered, full-stream filtration of contaminated fluids for a grinding machine 801, in accordance with an embodiment of the invention.

Filtering system 800 comprises one or more contaminated fluid collection tanks 802, one or more filtering devices 804, one or more drains 807, one or more contaminated fluid pumps 803, one or more clean fluid tanks 805, one or more coolant pumps 806, one or more pre-filters 809, one or more pre-filter backwash pumps 810, one or more pre-filter drains 811, one or more semi-clean fluid collection tanks 814, one or more cleaner pumps 815, one or more dresser pumps 816, a dresser 817, and one or more semi-clean fluid pumps 808. Contaminated fluid collection tank 802 is adapted to collect contaminated fluid 850 resulting from machining processes performed by machining equipment 801, a direction of flow of contaminated fluid 850 indicated by arrows 851. Pump 803 is adapted to pump contaminated fluid 850 from collection tank 802 to pre-filter 809, a direction of contaminated fluid flow shown by arrow 852. Pump 803 may be further adapted to automatically initiate pumping of contaminated fluid 850 upon receiving a signal from a sensor, optionally comprised in collection tank 802, indicating that the contaminated fluid has reached a predetermined high level in the collection tank.

Pre-filter 809 may be adapted to partially filter the contaminated fluid and may comprise other types of filters known in the art, for example, hydrocyclone filter, paper gravity filter, centrifuge filter, drum filter, candle filter and precoated filter, and/or paper and/or polymeric cartridge filtering, among others. Optionally, pre-filter device 809 may comprise a plurality of similar pre-filters, or a combination of different pre-filters. A semi-clean fluid 870, a direction of flow of which is indicated by arrow 857, flows from pre-filter 809 to semi-clean fluid tank 814. Semi-clean tank 814 is adapted to receive semi-clean fluid 870 from pre-filter 809, and is further adapted to store the semi-clean fluid for further filtering by filtering device 804. Semi-clean fluid flow from pre-filter 809 to semi-clean collection tank 814 may be gravity based, although in some embodiments of the invention, one or more pumps may be connected to the pre-filter adapted to pump semi-clean fluid 870 to the semi-clean collection tanks. Optionally, semi-clean tank 814 may be further adapted to send a signal to pump 803, automatically initiating the pump when semi-clean fluid 870 in the semi-clean tank is below a predetermined low level. Optionally, semi-clean tank 814 may be further adapted to send a signal to pump 803 automatically deactivating the pump when semi-clean fluid 870 in semi-clean tank 814 is at or above a predetermined high level.

Pre-filter 809 is connected to drain 811, which is adapted to receive a flushing fluid following backwash operation of the pre-filter. A backwash pump 810 pumps the flushing fluid, which may optionally comprise a relative small quantity of semi-clean fluid 870, from semi-clean tank 814 through pre-filter 809 at a relatively high pressure sufficient to substantially remove particulate contaminants from the pre-filter. A direction of flow of the flushing fluid is shown by arrow 856. In some embodiments of the invention, drain 811 may be connected to contaminated fluid collection tank 802 such that the flushing fluid is recycled into contaminated fluid 850. Optionally, drain 811 may be connected to semi-clean tank 814. Optionally, drain 811 may be connected to a briquetting machine (not shown) adapted to briquette the particulate contaminants in the flushing fluid following backwash. Optionally, the flushing fluid may be removed from filtering system 800 for other applications and/or uses.

Filtering device 804, which may be the same or substantially similar to filtering device 100 shown in FIG. 1A, is adapted to receive semi-clean fluid 870 pumped by pump 808 from semi-clean fluid collection tank 814, a direction of flow of the semi-clean fluid indicated by arrow 855. Filtering device 804 is further adapted to produce a clean fluid 860 (shown in clean tank 805) by filtering particulate contamination from semi-clean fluid 870. Optionally, filtering device 804 may be the same or substantially similar to filtering device 100A in FIG. 1B. In accordance with an embodiment of the invention, filtering device 804 may comprise a plurality of filtering devices 804, for example, 2, 3, 4, 5, 6, 7, 8, 9, 10, or more. The plurality of filtering devices 804 may be serially and/or parallelly connected, or any combination thereof. Filtering device 804 may be adapted to filter particles of one size range, or may optionally be adapted to filter particles of different size ranges by serially connecting filtering devices of successively decreasing filter grades, similar to filtering device 300 in FIG. 3E. Optionally, filtering device 804 may be connected, using proper connection means, to other types of filters known in the art, for example, hydrocyclone (cyclone) filter, paper gravity filter, centrifuge filter, drum filter, candle filter and precoated filter, and/or paper and/or polymeric cartridge filtering, among others.

Optionally, semi-clean fluid 870 may be pretreated before reaching filtering device 804. A pretreatment device 840 may comprise, for example, the use of agglomeration equipment; magnets, such as electro-magnets; chemical treatment; ultrasound treatment and other components; equipment such as fluid make-up system (water treatment, concentrate dosing station, level switch); tramp oil separator; and other filtration method such as hydrocyclone, centrifuge, paper gravity, drum filter, candle filter, and/or cartridge filter; or any combination thereof.

Clean fluid 860, a direction of flow of which is indicated by arrow 853, flows from filtering device 804 to clean fluid tank 805. Clean tank 805 is adapted to receive clean fluid 860 from filtering device 804, and is further adapted to store the clean fluid for use by machining equipment 801. Clean fluid flow may be gravity based, although in some embodiments of the invention, one or more pumps may be connected to outlet 107 in filtering device 100, or optionally to outlet 106A in filtering device 100A, for pumping clean fluid 860 to clean tank 805. Optionally, clean tank 805 may be further adapted to send a signal to pump 808, automatically initiating the pump when clean fluid 860 in tank 805 is below a predetermined low level. Optionally, clean tank 805 may be further adapted to send a signal to pump 808, automatically deactivating the pump when clean fluid 860 in tank 805 is at or above a predetermined high level. Optionally, clean tank 805 may be further adapted to send a signal to pump 803, automatically activating or deactivating the pump according to predetermined levels of clean fluid 860 in the tank. Optionally, clean tank 805 may be further adapted to send an activation signal and/or deactivation signal to any one pump, or any combination of pumps, comprised in filtering system 800. In some embodiments of the invention, clean tank 805 may be comprised inside grinding machine 801.

Connected to clean tank 805 is coolant pump 806, which is adapted to pump clean fluid 860 from clean tank 805 to grinding machine 801 for use as a coolant, the direction of clean fluid flow shown by arrow 853. Additionally connected to clean tank 805, in parallel to coolant pump 806, is cleaner pump 815, which is adapted to pump clean fluid 860 from clean tank 805 to grinding machine 801 for use as a cleaner fluid, the direction of clean fluid flow shown by arrow 853. Pump 806 and/or 815 may be further adapted to automatically initiate pumping of clean fluid 860 upon receiving a signal from a sensor, optionally comprised in clean fluid tank 805, indicating that the clean fluid has reached a predetermined high level in the clean tank. Optionally, pump 806 and/or 815 may be further adapted to automatically initiate pumping of clean fluid 860 upon receiving a signal from grinding machine 801.

Connected to semi-clean tank 814 is dresser pump 816, which is adapted to pump semi-clean fluid 870 from semi-clean tank 814 to grinding machine 801 for use by a dresser 817, the direction of semi-clean fluid flow shown by arrow 858. Dresser pump 816 may be further adapted to automatically initiate pumping of semi-clean fluid 870 upon receiving a signal from a sensor, optionally comprised in semi-clean fluid tank 870, indicating that the semi-clean fluid has reached a predetermined high level in the semi-clean tank. Optionally, pump 816 may be further adapted to automatically initiate pumping of semi-clean fluid 870 upon receiving a signal from grinding machine 801.

Filtering device 804 is connected to drain 807, which is adapted to receive flushing fluid following backwash operation of the filtering device. A direction of flow of the flushing fluid is shown by arrow 854. In some embodiments of the invention, drain 807 may be connected to contaminated fluid collection tank 802, such that the flushing fluid is recycled into contaminated fluid 850. Optionally, drain 807 may be connected to semi-clean tank 814 such that the flushing fluid is recycled into the semi-clean fluid 870. Optionally, drain 807 may include a tank and/or any system adapted to clean fluids, for example, a system having a filter, a cyclone, a centrifuge, a precipitation capability or the like. Optionally, the drain may be connected to a briquetting machine for briquetting of the contaminating part. Optionally, the flushing fluid may be removed from filtering system 800 for other applications and/or uses.

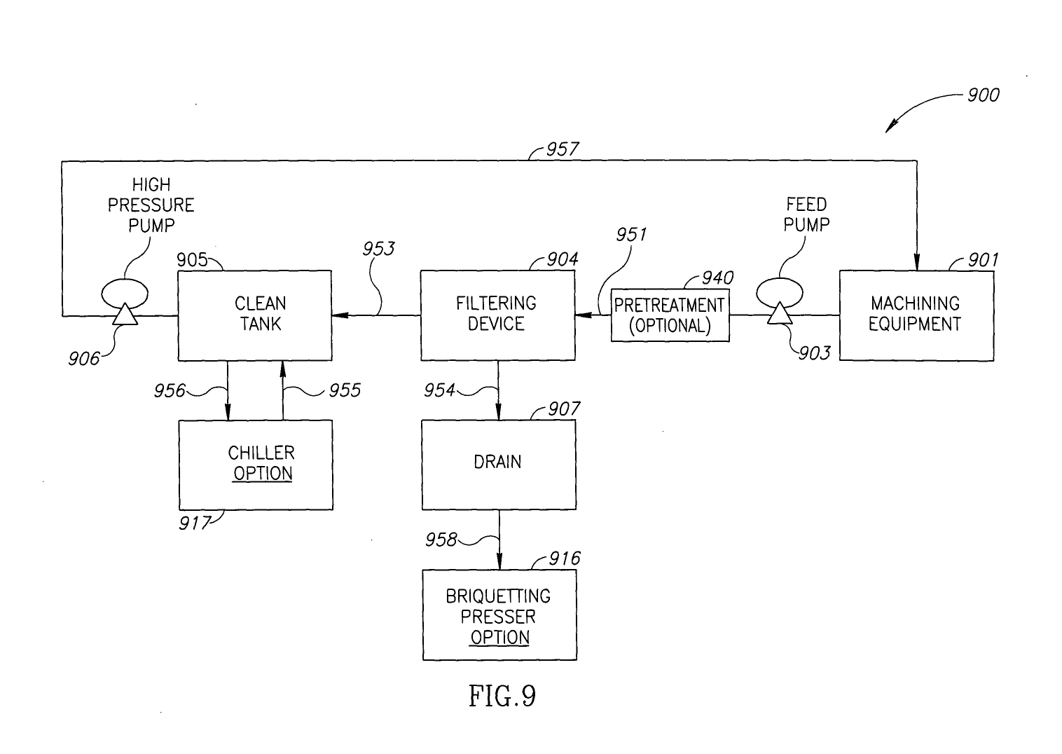

Reference is made to FIG. 9, which schematically shows a flow diagram of an exemplary filtering system 900 adapted to directly perform filtration of contaminated fluids for machining equipment 901, in accordance with an embodiment of the invention. Machining equipment 901 may be the same or substantially similar to machining equipment 401 shown in FIG. 4.

Filtering system 900 comprises one or more filtering devices 904, one or more drains 907, one or more feed pumps 903, one or more clean fluid tanks 905, and one or more clean fluid pumps 906 at a relatively high pressure (for example 5-100 bar, more specifically 10-70 bar). Optionally comprised in the filtering system may be a briquetting device 916 and/or a chiller 917.

Contaminated fluid resulting from machining processes performed by machining equipment 901, a direction of flow indicated by arrow 951, is pumped by feed pump 903, to filtering device 904. Pump 903 may be adapted to automatically initiate pumping of the contaminated fluid upon receiving a signal from machining equipment 901.

Filtering device 904, which may be the same or substantially similar to filtering device 100 shown in FIG. 1A, is adapted to receive the contaminated fluid pumped by pump 903, and is further adapted to produce a clean fluid by filtering particulate contamination from the contaminated fluid. Optionally, filtering device 904 may be the same or substantially similar to filtering device 100A in FIG. 1B. In accordance with an embodiment of the invention, filtering device 904 may comprise a plurality of filtering devices 904, for example, 2, 3, 4, 5, 6, 7, 8, 9, 10, or more. The plurality of filtering devices 904 may be serially and/or parallelly connected, or any combination thereof. Filtering device 904 may be further adapted to filter particles of one size range, or may optionally be adapted to filter particles of different size ranges by serially connecting filtering devices of successively decreasing filter grades, similar to filtering device 300 in FIG. 3E. Optionally, filtering device 904 may be connected, using proper connection means, to other types of filters known in the art, for example, hydrocyclone (cyclone) filter, paper gravity filter, centrifuge filter, drum filter, candle filter and precoated filter, and/or paper and/or polymeric cartridge filtering, among others.

Optionally, the contaminated fluid may be pretreated before reaching filtering device 904. A pretreatment device 940 may comprise, for example, the use of agglomeration equipment; magnets, such as electro-magnets; chemical treatment; ultrasound treatment and other components; equipment such as fluid make-up system (water treatment, concentrate dosing station, level switch); tramp oil separator; and other filtration method such as hydrocyclone, centrifuge, paper gravity, drum filter, candle filter, and/or cartridge filter; or any combination thereof.

The clean fluid, a direction of flow of which is indicated by arrow 953, flows from filtering device 904 to clean fluid tank 905. Clean tank 905 is adapted to receive clean fluid from filtering device 904, and is further adapted to store the clean fluid for use by machining equipment 901. Clean fluid flow may be gravity based, although in some embodiments of the invention, one or more pumps may be connected to outlet 107 in filtering device 100, or optionally to outlet 106A in filtering device 100A, for pumping the clean fluid to clean tank 905. Optionally, clean tank 905 may be further adapted to send a signal to pump 903, automatically initiating the pump when the clean fluid in tank 905 is below a predetermined low level. Optionally, clean tank 905 may be further adapted to send a signal to pump 903, automatically deactivating the pump when the clean fluid in tank 905 is at or above a predetermined high level. Optionally, clean tank 905 may be further adapted to send an activation signal and/or deactivation signal to any one pump, or any combination of pumps, comprised in filtering system 900. In some embodiments of the invention, clean tank 905 may be comprised inside machining equipment 901. Optionally, chiller 917 is connected to clean tank 905, the chiller adapted to cool the clean fluid comprised in the tank. Directions of clean fluid flow between clean tank 905 and chiller 917 are indicated by arrows 955 and 956.

Connected to clean tank 905 is pump 906, which is adapted to pump the clean fluid at a relatively high pressure from clean tank 905 to machining equipment 901, the direction of clean fluid flow shown by arrow 957. Pump 906 may be further adapted to automatically initiate pumping of the clean fluid upon receiving a signal from a sensor, optionally comprised in clean fluid tank 905, indicating that the clean fluid has reached a predetermined high level in the clean tank. Optionally, pump 906 may be further adapted to automatically initiate pumping of the clean fluid upon receiving a signal from machining equipment 901.

Filtering device 904 is connected to drain 907, which is adapted to receive flushing fluid following backwash operation of the filtering device. A direction of flow of the flushing fluid is shown by arrow 954. In some embodiments of the invention, drain 907 may be connected to briquetting machine 916 adapted to briquette the particulate contaminants in the flushing fluid following backwash. Optionally, drain 907 may include a tank and/or any system adapted to clean fluids, for example, a system having a filter, a cyclone, a centrifuge, a precipitation capability or the like. A direction of flow of the flushing fluid comprising the particulate contaminants is indicated by arrow 958. In some embodiments of the invention, the flushing fluid following the briquetting may be recycled into clean tank 905. Optionally, the flushing fluid may be removed from filtering system 900 for other applications and/or uses.

In the description and claims of embodiments of the present invention, each of the words, “comprise” “include” and “have”, and forms thereof, are not necessarily limited to members in a list with which the words may be associated.

The invention has been described using various detailed descriptions of embodiments thereof that are provided by way of example and are not intended to limit the scope of the invention. The described embodiments may comprise different features, not all of which are required in all embodiments of the invention. Some embodiments of the invention utilize only some of the features or possible combinations of the features. Variations of embodiments of the invention that are described and embodiments of the invention comprising different combinations of features noted in the described embodiments will occur to persons with skill in the art.

1-26. (canceled)

27. A system for filtering oils and/or emulsions comprising: one or more filtering devices comprising stacked filtering elements configured to filter oils and/or emulsions; one or more tanks configured to hold oils and/or emulsions; and one or more pumps configured to pump oils and/or emulsions.

28. The system of claim 27, wherein the system is configured for filtering oils and/or emulsions used in machining operations.

29. The system of claim 27, wherein the tank is a contaminated fluid tank configured to hold at least one of non-filtered oils, pre-filtered emulsions, mixed non-filtered and filtered oils and non-filtered and filtered emulsions.

30. The system of claim 27, wherein the tank is a semi-clean fluid tank configured to hold at least one item selected from the group consisting of pre-filtered oils, pre-filtered emulsions, mixed pre-filtered and filtered oils and mixed pre-filtered and filtered emulsion.

31. The system of claim 27, wherein the tank is a clean fluid tank configured to hold filtered oils and/or emulsion.

32. The system of claim 27, further comprising any one of a drain, a briquetting machine, a pre-filter, a polisher filter.

33. The system of claim 32, wherein the pre-filter is a paper and/or polymeric cartridge filter.

34. The system of claim 32, wherein the polisher filter is a paper and/or polymeric cartridge filter.

35. The system of claim 27, wherein the pumps are configured to pump at least one item selected from the group consisting of non-filtered oils, non-filtered emulsions, pre-filtered oils, pre-filtered emulsions, mixed non-filtered and pre-filtered oils, mixed non-filtered and pre-filtered emulsions, mixed filtered and pre-filtered oils, mixed filtered and pre-filtered emulsions, filtered oils and filtered emulsions.

36. The system of claim 27, wherein the filtering devices may be connected in series and/or in parallel.

37. The system of claim 27 wherein the filtering devices are configured to filter particulate contaminants in only one size range.

38. The system of claim 27, wherein the filtering devices are configured to filter particulate contaminants of various size ranges.

39. The system of claim 27, wherein the pumps may be automatically activated and wherein the automatically activated pumps may be automatically deactivated.

40. The system in accordance with claim 27, wherein any one of the filtering devices and pre-filter is configured to perform automatic backwash.

41. A method for filtering oils and/or emulsions used in machining operations comprising: filtering oils and/or emulsions with one or more filtering devices comprising stacked filtering elements configured to filter oils and/or emulsions; holding oils and/or emulsions in tanks; and pumping oils and/or emulsions.
